(19) United States
(12) Patent Application Publication
(10) Pub. No.: US 2025/0255273 A1
(43) Pub. Date: Aug. 14, 2025

(54) AUTOMATED CANINE LINE-UP FOR DETECTION DOG RESEARCH

(71) Applicant: Texas Tech University System, Lubbock, TX (US)

(72) Inventors: Nathaniel J. Hall, Lubbock, TX (US); Paola Tiedemann, Lubbock, TX (US); Edgar Aviles Rosa, Lubbock, TX (US); Mallory DeChant, Lubbock, TX (US)

(21) Appl. No.: 19/172,058

(22) Filed: Apr. 7, 2025

Related U.S. Application Data
(63) Continuation-in-part of application No. PCT/US2023/076225, filed on Oct. 6, 2023.
(60) Provisional application No. 63/414,302, filed on Oct. 7, 2022.

(51) Int. Cl. A01K 15/02

(52) U.S. Cl. CPC A01K 15/02

(57) ABSTRACT

A system for training detection dogs comprising a central computer; a plurality of olfactometers operably connected to the central computer, each olfactometer comprising one or more sampling ports; a plurality of odor channels in fluid communication with the sampling port; an independent controller operably coupled to the plurality of odor channels; and one or more sensors connected to the one or more sampling port; a cover disposed to the one or more covers and uncover one or more of the one or more sampling ports; a cover controller operably coupled to the one or more covers; and a feeder operably coupled to the cover controller.

### CROSS-REFERENCE TO RELATED APPLICATIONS

This application claims priority to and is a continuation-in-part of International Application No. PCT/US2023/076225, filed Oct. 6, 2023, which claims priority to U.S. Provisional Application Ser. No. 63/414,302, filed Oct. 6, 2023, the entire contents of which are incorporated herein by reference.

### STATEMENT OF FEDERALLY FUNDED RESEARCH

This invention was made with government support under Grant/Contract No. 70RSAT20CB000001 awarded by the U.S. Department of Homeland Security. The government has certain rights in the invention.

### TECHNICAL FIELD OF THE INVENTION

The present invention relates in general to detection dog research. In particular, the present invention relates to an automated line-up for detection dog research.

### BACKGROUND OF THE INVENTION

Detection dogs' broad and important use for homeland security and military applications highlights the need for research and development in detection dog proficiency assessments and training. Although technological advances have been made for equipment a dog may use in the field such as hearing (e.g., EAR PRO™; www.rexspecs.com/) and eye protection (e.g., Rex Specs™; www.rexspecs.com/), little development has been done to advance technology that improves dog training proficiency and assessment or the development of research tools to advance this field [sce notable exceptions: (1, 2)].

Detection dogs are frequently tested in “line-up” procedures or “odor recognition tests” in which a series of items (suitcases, paint cans, etc.) are placed in a line or circle and the dog is asked to search them. Such procedures are frequently used for research as well (3-7). Line-up procedures are commonly used in training and research because they are inexpensive, easy to setup, and can be adapted to different settings. Nevertheless, line-up paradigms have their limitations particularly for research purposes. The main limitation of these procedures is that conducting double blind testing, where both the dog and the handler are blind to the presence of an odor, is manually time-consuming and requires significant labor. In a line-up, double-blind conditions are ensured by having multiple experimenters in addition to the dog handler. Ensuring double-blind conditions is critical, particularly for research purposes, as a handler's knowledge or beliefs of the presence of a target can influence dogs' behavior (4, 8). In addition, when using a line-up, additional efforts are necessary to control for a variety of other potential cues dogs may leverage (scent marks on the samples from previous dogs, memorizing odor order on repeated trials, using unintentional auditory cues, etc.). Furthermore, each trial in a line-up procedure requires substantial effort to prepare odorant placement, limiting the data collection capacity of the experimenter. Some of the limitations of a line-up paradigm can be overcome by the development of automated systems that can present samples to the dog, detect dogs' responses, and collect the data automatically [e.g., (2)]. The development of an automated system with these capabilities will ensure double-blind conditions, maximize data collection, and reduce labor. This will result in more accurate and reliable data in detection dog research.

Different attempts have been made to develop automated systems in the past. Mancini et al. (9) used pressure sensitivity pads to automatically record cancer-screening dogs' responses to different samples. This system automated the recording of a dog's responses, but the sample presentation and the delivery of the reward continued to be manual. Recently, Edwards (1) designed a scent wheel that automated data collection and the delivering of the reinforcer. Edwards trained dogs to rotate the scent wheel by activating an omnidirectional switch until they found a target odor. The dogs were further trained to alert to a target odor by holding their nose in the sample port for at least 1 s. Infrared beam sensors were used to measure the nose hold duration, and a computer program recorded dog responses. A correct response resulted in the activation of a feeder to deliver a food reward. This system moved the field forward by providing an automated and controlled “scent wheel,” but it still has some applicable limitations. For instance, training dogs to operate the wheel can be challenging, and the paradigm does not resemble detection dog training. Furthermore, odor samples are still needed to be placed manually in the wheel, and the system did not have the odor control that is available with other automated systems such as olfactometers. More recently, Jendrny et al. (2) used a novel automated system to train COVID-19 detection dogs. This system shows promise; however, details of the apparatus and operation were not fully detailed for replication.

An olfactometer is an instrument that uses odor-free air to carry an odorant and present it to a participant for evaluation (10, 11). In general, olfactometers use filtered or compressed air to carry the headspace of an odor jar into a sampling port where the subject can smell it. Using computer-controlled valves, olfactometers allow the experimenter to control the odor concentration and the duration of odor exposure, resulting in optimal odorant stimulus control during testing. Because of this, olfactometers have been commonly leveraged for olfactory threshold and discrimination studies in rodents (12), humans (13), and dogs (5, 14-20). However, these systems typically have a single port and do not frequently represent the more frequently used “line-up” that deployed detection dogs are frequently trained on.

Thus, to further advance and improve detection dog research and bridge gaps between research methodologies and training used for operational detection dogs, there remains the need to develop a behavioral training and testing apparatus that combines the benefits of odorant stimulus control of an olfactometer but does so in a more realistic search setting such as a “line-up” in which detection dogs are routinely evaluated.

### SUMMARY OF THE INVENTION

As embodied and broadly described herein, an aspect of the present disclosure relates to a system for training detection dogs comprising: a central computer; a plurality of olfactometers operably connected to the central computer, each olfactometer comprising: one or more sampling ports; a plurality of odor channels in fluid communication with the one or more sampling ports; an independent controller operably coupled to the plurality of odor channels; and a sensor connected to the one or more sampling ports; one or more covers disposed to cover and uncover one or more of the one or more sampling ports; a cover controller operably coupled to the cover; and a feeder operably coupled to the cover controller. In one aspect, independent controller of the one or more sampling ports comprises a program to present an odor from one of the plurality of odor channels to the one or more sampling ports. In another aspect, the one or more sensor of the one or more sampling ports is disposed to measure a nose hold of a dog at the one or more sampling ports. In another aspect, the cover controller comprises a program to operate the one or more covers. In another aspect, the cover controller comprises a program to operate the feeder when one or more specified conditions are met. In another aspect, the one or more sensors are operably configured to determine when one or more specified conditions are met. In another aspect, the central computer comprises a program to operate the system to train detection dogs to indicate detection of a specified odor from the plurality of odor channels. In another aspect, each of the plurality of olfactometers is remotely controllable. In another aspect, each of the plurality of olfactometers is remotely controllable by long-range radio. In another aspect, the system for training detection dogs is portable.

As embodied and broadly described herein, an aspect of the present disclosure relates to a kit for training detection dogs comprising: a central computer; a plurality of olfactometers configured to be operably connected to the central computer, each olfactometer comprising: one or more sampling ports; a plurality of odor channels configured to be placed in fluid communication with the one or more sampling ports; an independent controller configured to be operably coupled to the plurality of odor channels; and a sensor configured to be connected to the one or more sampling ports; one or more covers disposed to cover and uncover one or more of the one or more sampling ports; a cover controller configured to be operably coupled to the one or more covers; a feeder configured to be operably coupled to the cover controller; and one or more tools to assemble the system. In one aspect, the independent controller of each sampling port is operable to be programmed to present an odor from one of the plurality of odor channels to the one or more sampling ports. In another aspect, the one or more sensors of the one or more sampling ports is configured to be disposed to measure a nose hold of a dog at the one or more sampling ports. In another aspect, the cover controller is operable to be programmed to operate the one or more covers. In another aspect, the cover controller is operable to be programmed to operate the feeder when one or more specified conditions are met. In another aspect, the one or more sensors are operable to be configured to determine when one or more specified conditions are met. In another aspect, the central computer is operable to be programmed to operate the system to train detection dogs to indicate detection of a specified odor from the plurality of odor channels. In another aspect, each of the plurality of olfactometers is remotely controllable. In another aspect, each of the plurality of olfactometers is remotely controllable by long-range radio. In another aspect, each of the plurality of olfactometers is portable.

As embodied and broadly described herein, an aspect of the present disclosure relates to a method of training detection dogs comprising: providing a dog for training; providing a system for training detection dogs comprising: a central computer; a plurality of olfactometers operably connected to the central computer, each olfactometer comprising: one or more sampling ports; a plurality of odor channels in fluid communication with the sampling port; an independent controller operably coupled to the plurality of odor channels; and one or more sensor connected to the one or more sampling ports; one or more covers disposed to cover and uncover one or more of the one or more sampling ports; a cover controller operably coupled to the one or more covers; and a feeder operably coupled to the cover controller; operating the system to provide one or more odors at the one or more sampling ports from the plurality of odor channels of each of the one or more sampling ports; allowing the dog to sniff each sampling ports; and rewarding or not rewarding the dog according to a performance of the dog in detecting the one or more odors. In another aspect, the independent controller of the one or more sampling ports comprises a program to present an odor from one of the plurality of odor channels to the one or more sampling ports. In another aspect, the one or more sensors of each of the one or more sampling ports is disposed to measure a nose hold of a dog at the one or more sampling ports. In another aspect, the cover controller comprises a program to operate the one or more covers. In another aspect, the cover controller comprises a program to operate the feeder when one or more specified conditions are met. In another aspect, the one or more sensors are operably configured to determine when one or more specified conditions are met. In another aspect, the central computer comprises a program to operate the system to train detection dogs to indicate detection of a specified odor from the plurality of odor channels. In another aspect, each of the plurality of olfactometers is remotely controllable. In another aspect, each of the plurality of olfactometers is remotely controllable by long-range radio. In another aspect, each of the plurality of olfactometers is portable.

### BRIEF DESCRIPTION OF THE DRAWINGS

For a more complete understanding of the features and advantages of the present invention, reference is now made to the detailed description of the invention along with the accompanying figures, in which:

FIG. 1 shows an embodiment of the line-up design.

FIGS. 2A, 2B, 2C, and 2D show an olfactometer design. FIG. 2A shows a common air source and rotameter airflow control. FIG. 2B shows three ports and a panel cover that moves up and down to cover the ports. FIG. 2C shows jars connected to manifolds. FIG. 2D shows an overall airflow design for a single olfactometer.

FIG. 3 shows a dog alerting to a port containing a target odor. Infrared sensors located at the front of the port measure the nose hold duration, providing an objective recording of a dog's alert.

FIG. 4 shows a training progression.

FIGS. 5A-5C shows a progression of search-related behaviors in dogs (N=12) within the first 21 training days.

FIGS. 6A-6D show dogs' (N=12) detection performance in the line-up olfactometer during the first 21 days of training.

FIG. 7 shows Dogs' (N=12) mean±standard error of the proportion of correct responses during phase 3 and the control test.

FIG. 8 shows a photoionization detector (PID) analysis of tracer odor. The top figure shows the olfactometer stimulation over a 40-min period. The bottom figure shows an enlarged view of two representative stimulations.

FIG. 9 shows a total ion chromatogram (TIC) of diphenylamine detection from olfactometer sampling.

FIG. 10 shows abundance of diphenylamine obtained from olfactometer output across sampling replicates.

FIGS. 11A and 11B show total ion chromatograms (TIC) from olfactometer blank samplings. FIG. 11A shows a pre-powder purge. FIG. 11B shows a post-powder purge.

FIG. 12 shows an image of an apparatus for remotely controlling one or more olfactometers of the present invention.

FIG. 13 shows each dog's accuracy (proportion of correct responses that includes hits and correct rejections) by group (experimental and control) during the different periods of an experiment.

FIG. 14A shows the accuracy for an experimental group of dogs was higher (90.68%) than that for the control group of dogs (60.05%) in the operational context, and FIG. 14B shows another analysis accuracy in the operational context.

FIG. 15A shows an image of a dog searching six individual Bluetooth automated olfactometers, and FIG. 15B shows an image of the six individual Bluetooth automated olfactometers.

FIG. 16 shows individual dog performance by group and period.

FIG. 17 shows dog performance by group (experimental and control).

FIG. 18 shows an embodiment of the method of the present invention.

FIG. 19A shows an experimental setup with an embodiment of the present invention. FIG. 19B shows a scent wall within the experimental setup of FIG. 19A.

### DETAILED DESCRIPTION OF THE INVENTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure. Modifications as such have already been made to include Bluetooth rather than USB connection, odor ports included within each olfactometer rather than ports as a panel, and battery powered operation.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

One objective of the present invention is to develop an automated computer-driven olfactory line-up task for dogs that resembles a search scenario, leverages olfactometer odor stimulus control, and objectively and automatically scores dog responses. A further objective is to provide details about the apparatus schematics and training procedure such that other researchers can use, improve, and further advance the detection dog research field.

Currently, there is a need to develop technology that facilitates and improves detection dog research. The aim of this research was to develop an automated computer-driven olfactory line-up task. The apparatus consisted of three olfactometers. Each olfactometer was equipped with flow meters to regulate air flow and dilution and six solenoid valves connected to odor jars. Each olfactometer generated an odor which was carried to an odor port where the dogs sample it. The olfactometer's valves were activated by a microcontroller, and a Python program was built to control each olfactometer and randomize and balance the odor presentation. Dogs (N=12) received one or two 40-trial training sessions in a day where they progressed through a series of training phases where they learned to detect and alert to double-base smokeless powder (SP). An “alert” consisted of a 4-s nose hold. This was measured by infrared sensors in the ports. For each trial, the apparatus recorded dogs' search latency, sniff time, port entries, and response. All this information was automatically recorded in a csv file. A photoionization detector (PID) and solid-phase microextraction followed by gas chromatography-mass spectrometry (SPME-GC/MS) were used to evaluate the odor dynamics and to instrumentally verify odor presence and clearance. A control test was conducted at the end of the training to ensure dogs were alerting exclusively to the odorant. All 12 dogs readily learned to operate the apparatus within 23 days, and all exceeded 85% accuracy. Control tests indicated dogs were leveraging only olfactory cues and not unintentional cues such as auditory cues from the apparatus. Analytical data showed that odor was detected in the port immediately after the activation of a valve and that odor clearance occurred immediately after the valve was closed. The apparatus developed was easy to operate by the dogs and allowed substantial data collection using double-blind testing procedures in a very short period at an affordable cost point for research equipment (˜$5,000 USD). The apparatus may prove to be a useful research tool to provide optimal odor stimuli control, ensure double-blind conditions, reduce labor, and significantly increase the amount of data collected.

Apparatus. Olfactometer Line-Up Design.

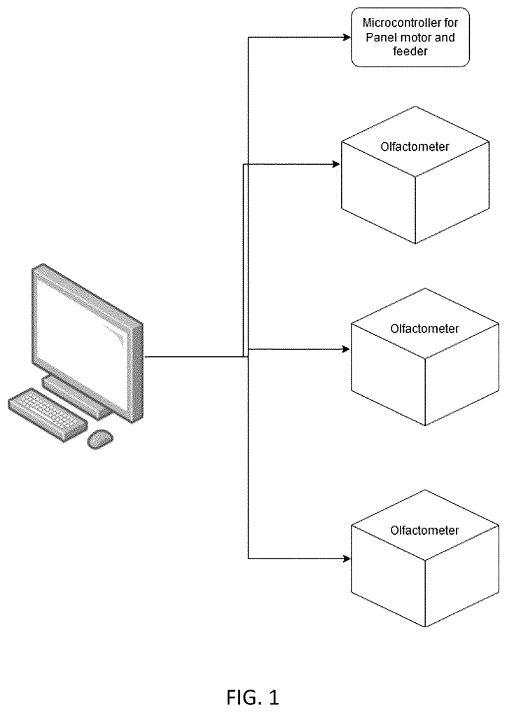

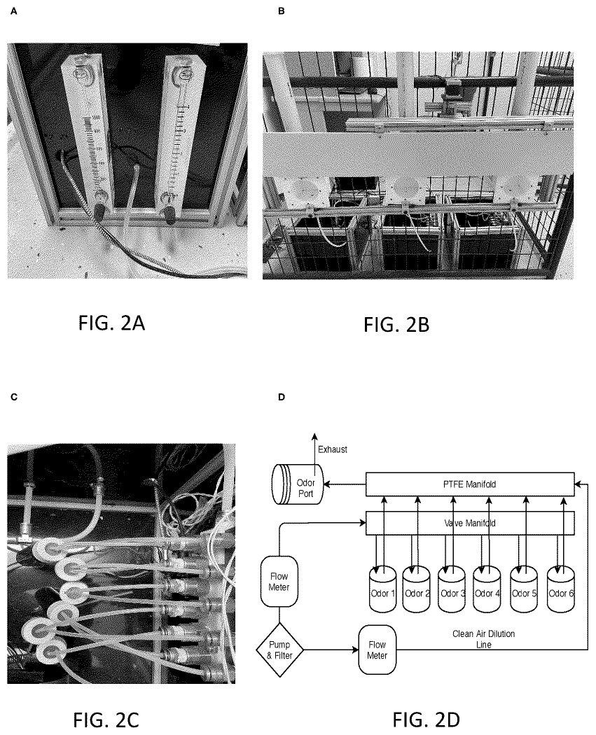

To produce a three-alternative line-up for dogs to search, three separate olfactometers, each one with six odor channels, and a panel were produced. Each olfactometer was controlled by its own microcontroller, and each olfactometer independently controlled the odor presented to one of the three sampling ports. The olfactometers were controlled via a central computer (FIG. 1) that interfaced with a microcontroller (Arduino Nano BLE Sense™ board) that controlled the olfactometer's valves. The central computer also interfaced with a fourth microcontroller that was responsible for driving up and down a motor (100-mmLinear Rail Guide with NEMA17 stepper motor) that held a panel covering the olfactometer ports (FIGS. 2A,-2D). Additionally, this microcontroller interfaced with an automated feeder (PetTutor™) via Bluetooth, which delivered the food treats.

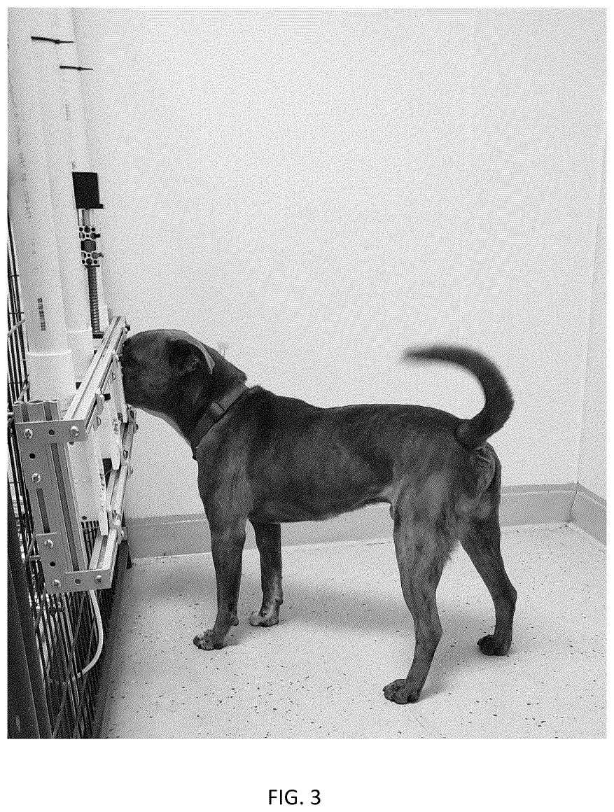

Three polytetrafluoroethylene (PTFE; Teflon™) sampling ports were mounted to an aluminum T-slot frame and spaced 35.5 cm apart and were 58.4 cm from the ground. The PTFE ports were mounted to the side of a panel (FIG. 2B). This panel was moved up and down by a motor to allow or prevent dogs' access to the ports at the beginning or end of each trial, respectively. At the bottom of each odor port was a ⅛-in. NPT to tube fitting by which the odorant was introduced to the sampling port. At the top of each port was a ¾-in. NPT fitting connected to a 3.8-cm PVC fitting. Inside the PVC fitting was a 40×40-mm fan (7 CFM), which served to exhaust the odorant at the end of each trial (FIG. 2B). The fan would blow the odorant along a PVC pipe to exhaust it out of the room. Infrared beam sensors were mounted to the T-slot channel on the outside entrance of each odor port to measure canine nose port entries and to record the duration of the nose hold to evaluate dogs' response (FIG. 3).

Odor was generated by each olfactometer independently. Each olfactometer was fed from a common air supply and/or independent air supplies generated by a high-flow air pump and cleaned using a charcoal filter. The common airline connected to the back of the olfactometers (FIG. 2A), which was regulated by two rotameters (Dwyer VFB™). One rotameter regulated a clean airline (FIG. 2D) and ranged from 1 to 4 l/min (LPM), and the other rotameter regulated the odor line between 0.1 and 1 LPM. The clean airline was directly connected to a final PTFE manifold (white manifold, FIG. 2C), which flowed unrestricted to the odor port. This provided continuous airflow for clearing the odor from the port between trials and dilute the odorant. The odor line was connected to a manifold bank with six 12-V solenoid valves. Stainless steel push-to-connect fittings connected a 0.16 ID×0.32 OD PTFE tubing from the manifold to a borosilicate glass jar containing the odorant. The lid of the glass jar was a lid designed for VOC sampling with a PTFE and silicone septa lid. A small hole was pierced with stainless steel tubing, which allowed the PTFE tubing to be directly inserted into the lid (FIG. 2C). A second exit line was also inserted into the jar, connecting a path for the headspace to exit when air was introduced. The exit airline was connected to a stainless steel check valve, to prevent backward flow, and then to the final PTFE manifold. In the manifold, the odorant air is mixed with the continuous clean line and exited at the odor port for the dog to sample (FIG. 2D).

Electronic Design. A custom-designed printed circuit board (PCB) was made to control each olfactometer, the panel, and the feeder. The PCB integrated an Arduino Nano BLE 33 as a microcontroller; a 12-V power supply; a Darlington transistor array; and breakouts for a motor drive, infrared (IR) beam pairs, solenoids valves, and other sensor peripherals.

Construction. The olfactometer itself was built as a simple cube with 30.5-cm sides. T-slot metal channel served as the frame with 0.63-cm polypropylene plastic fitted within the T-slot. The construction was custom built and can be customized to fit any desired size and shape.

Programming. A microcontroller code (Arduino code) was developed with a simple communication interface between the computers to activate olfactometer valves, and the same code can be uploaded to each olfactometer as long as each olfactometer is given a unique name. For the computer, a training program was developed for use with Python 3.x or higher. The Python program was built to control each olfactometer and randomize and balance the odor presentation in each port. The program was built to randomize the odor presentation but ensures that the odor appeared approximately the same number of times in each port. This program can be modified for different research or training purposes. For instance, experimenters can easily change the algorithm to change the odor presentation rate and reinforcement schedules and to activate multiple valves at a time to create odor mixtures.

The program outputs a CSV file for each instance of the program. The file is labeled with the entered dog name and a timestamp. The data sheet produces a row for each trial completed, storing information put in by the user and trial specific information. This includes the odors presented in each port, the timestamp of the start of the trial, the latency for the dog to start searching (first nose entry), the number of nose entries to each port, the total sniffing duration to each port, and a list record of each poke and its duration.

Subjects. The study was conducted at the Texas Tech University (TTU) Canine Olfaction Research and Education Lab (CORE). For this study, the inventors tested two independent cohorts of six mixed breed dogs as shown in Table 1.

TABLE 1

| | | | Approx- | Visual | Average |
|---|---|---|---|---|---|
| | | Reproductive | imate | Breed | Weight |
| Name | Cohort | Status | Age | appearance | (kg) |
| Bruce | One | Neutered Male | 3 y | Pit mix | 24.02 |
| Bullseye | Two | Neutered Male | 2 y | Pit mix | 22.50 |
| Buster | Two | Neutered Male | 3 y | Pit mix | 21.50 |
| Charles | Two | Neutered Male | 1 y | Husky mix | 23.00 |
| Charm | One | Spayed Female | 1 y | Lab mix | 22.43 |
| Dale | Two | Neutered Male | 4 y | Pit mix | 30.00 |
| Maxine | One | Spayed Female | 2 y | German | 24.20 |
| | | | | Shepherd mix | |
| Phantom | One | Neutered Male | 1 y | Lab mix | 26.28 |
| Pumpkin | One | Neutered Male | 1 y | Lab mix | 28.16 |
| Raven | One | Spayed Female | 1 y | Lab mix | 22.76 |
| Sasha | Two | Spayed Female | 9 y | Lab mix | 22.00 |
| Wishbone | Two | Neutered Male | 2 y | Pit mix | 21.25 |

Cohorts were tested 4 months apart from each other. This was due to space limitations in the training facility. All dogs had no previous experience or training in scent detection. Participants were selected from local shelters and rescue organizations as a partnership with the inventors' train-for-adoption program. Dogs were selected based on their food motivation, size (20-30 kg), age (<10 years), and boldness (e.g., were not afraid and approached the experimenter during the selection trials). Dogs were housed in indoor kennels (2.43×1.22 m) in a climate-controlled room with free access to an outdoor kennel (2.43×1.22 m). Dogs received 25% of their daily food ration in the morning (˜08:00) and the remaining in the afternoon (˜16:00). Dogs had free access to water in their kennels and during the training sessions. In addition, dogs received two daily walks and/or play sessions in between training as part of the inventors' lab enrichment program. All procedures and animal handling were approved by the TTU Institutional Animal Care and Use committee (protocol #19093-10).

Training. For training, the odor line air flow was set to 1 LPM, and the continuous airline was set to 2 LPM to produce a 33% air dilution of the target odorant. This air dilution was also used for the distractors. Dogs received one or two 40-trial sessions a day based on trainer availability. Dogs were trained up to 5 or 6 days in a week. If dogs were trained twice in a day, each session was at least 2 h apart from each other. During a trial, one sampling port had the target odor, and the other two ports had distractor odors unless it was a blank trial where none of the ports contained the target odor. Dogs progressed through a series of training phases where the inventors trained them to alert to the target odor and ignore the distractors. Training phases were set within the Python program developed for this system and are described in detail below. These training phases show how the inventors conducted the training, but they can be modified based on individual dog performance or trainer experience and expertise.

Phase 1. During this phase, the inventors used a biologically interesting odor (food) to promote the search of the apparatus. In this case, the odor of hotdog was used in the initial training phase. The remaining odor channels were filled with distractor (non-target) odors including the following: an empty vial, cotton gauze, latex glove, mineral oil, and limonene (10-3 v/v dilution in mineral oil). These distractors were selected as they are common laboratory ingredients to prepare odorants and include a novel strong odor (limonene). The same distractors were used throughout the different training phases. During training phase 1, the computer interface showed the port that contained the target odor. This was to allow the handler to reinforce correct responses or approximations and facilitate and accelerate training.

During the first training session, dogs were introduced to the room with the equipment off. This was to habituate the dogs to the room. During this habituation period, the handler reinforced every time the dog spontaneously investigated the ports. Once dogs were comfortable in the room and investigating the ports, the handler turned on the air pump to habituate dogs to the sound of the pump. Dogs were usually habituated to the room within 10-20 min. After habituation, the computer program was initiated, and odor trials started. Each trial started by lifting the panel covering the three odor ports and terminated when the dog held its nose in the correct port by the duration criterion set by the handler. At the beginning of the trial, the handler prompted the dog (e.g., tapping the panel with their finger) to investigate all three ports. A nose hold criterion of 0.25 s was initially set, such that initial investigation of the correct port triggers a “beep” from the computer and activates the feeder delivering a food reward. Incorrect responses (i.e., a 0.25-s hold to an incorrect port) were scored as incorrect but did not have any programmed consequences. If a dog failed to trigger the IR sensor at the 0.25-s criterion for the correct port after 20 or more seconds, the handler placed a treat in the correct port, to prompt the dog to enter and hold their nose. This will trigger the IR beam and feeder. After a correct response in each trial, the panel goes down covering the ports, and the exhaust fans were activated for 15 s to clear the odorants from the ports before the initiation of the following trial.

The location of the target odor and distractor odors was randomized by the computer program for each trial. The trial randomization occurs by first determining (1) whether a trial will contain a target odor, (2) which port will contain the target if that trial was programed to contain a target odor (counterbalanced across the three ports), and (3) randomly selecting between the five distractor odors for the non-target olfactometers independently. Thus, each olfactometer selects the distractor independently, and in most trials, the two distractors would be different but could also be the same (if the same odor happens to be selected by the two distractor olfactometers for that trial).

Training with a nose hold criterion of 0.25 s continued until dogs independently searched the line-up at the handler's command (e.g., “search” or “find it”) and activate the IR beams on their own. The nose hold criterion was then increased in 0.5-s steps after every session a dog independently activated the IR beams until reaching a 2-s nose hold criterion. Once reaching the 2-s criterion, accuracy was assessed daily by calculating the number of trials the dogs made a 2-s nose hold only to the port presenting the target odor, and not to other ports. If the dog reached 85% correct responses or higher in a day, the target odor was changed from a biologically interesting odor (hotdog) to a main target odor. For this study, the inventors used double-base smokeless powder (Hodgdon®) as the main target odor. To facilitate odor transition, during the first session with smokeless powder (SP), the nose hold criterion was reduced from 2 to 1 s, and the handler marked (with a clicker or a “yes”) every time the dog poked the correct port. This was done for their first 10 trials of the session, and after, the dog had to alert on its own. If the dog showed problems transitioning to SP after trial 20, the handler marked again the correct port to prevent extinction. Training with SP continued until dogs averaged at least 85% correct responses in two consecutive training sessions. At this point, the nose hold criterion was increased from 2 to 4 s in 0.5-s steps. The step size and return to a previous step size was made based on trainer expertise and dog's performance in a session. Once dogs reached an accuracy of 85% or higher with a 4-s nose hold criterion, dogs advanced to phase 2. If a dog had difficulty or showed a drop in motivation, the dog could return to a previous level of training including re-introducing food odor to re-build motivation. This was done on occasion for some dogs.

Phase 2. In phase 2, the computer program was advanced such that testing occurred blinded (the computer did not show the port containing SP) and provided consequences for a false alert or incorrect responses. If a dog made a false alert, the trial would terminate without the food reward. Phase 2 training continued until dog performance was 85% correct or higher in two consecutive sessions. If a dog showed decreased motivation or continued poor performance at this level, the dog could be returned to a previous phase based on trainer expertise.

Phase 3. This phase introduced blank trials in which no port contained the target odor. This occurred on 10% of the trials (e.g., 4 out of the 40 trials), and they were randomly distributed within each block of 10 trials. If the dog alerted to a non-target odor, the trial was scored as incorrect and terminated without reward. In addition, during this phase, the inventors also added a time limit of 45 s for a dog to search the ports and make a response. If the dog failed to search all three ports within 45 s, a “timeout” was recorded, and the trial was terminated and scored as incorrect. If a dog searched all three ports and did not alert to any port after 4 s of searching the last port, an “all-clear” response was scored. An all-clear response was recorded as a correct response during blank trials and an incorrect response for trials in which SP was presented. Correct all clears were not reinforced with food. The reinforcer for an all clear response was to simply advance to the next search, because this is common practice with detection dogs (e.g., if a dog does not find a target in one room, they move onto the next). A dog was considered fully trained if they scored at least 85% correct responses in phase 3 training for two consecutive sessions.

Control Testing. To verify dogs were utilizing olfactory cues and not unintentional cues delivered by the olfactometer (e.g., solenoid valve “clicks,” unintentional air flow changes, etc.) a control session of 10 trials was conducted after the dog reached training criterion. The control session was identical to a regular session with the exception that the air flow into the odorant jars was “unplugged” such that odorant air was not introduced to the odor port. Everything else was identical, and programmed consequences remained in effect.

Odor Delivery and Clearance Validation. A photoionization detector (PID, 200B miniPID, Aurora Scientific®, Canada) was used to validate odor delivery of a tracer odorant. The miniPID was placed in the odor port to validate what the dog was receiving when searching a port during and after a trial. With the miniPID inside the port, the inventors activated the odor valve for 30 s (typical duration of a trial). After the 30 s, the odor line was stopped for 30 s to allow odor clearance and activated again. This cycle was repeated 40 consecutive times. For this test, the olfactometer microcontroller (Arduino) algorithm was modified to run the odor cycle automatically and to send a voltage signal to synchronize valve activation with PID readings. Analog voltage readings from the PID and the microcontroller indicating odor activation were sampled at 30 Hz using a LabJack (U6) DAQ.

The tracer odorant used for this was limonene (CAS: 5989-54-8) diluted in mineral oil (10-1 v/v) to facilitate odor detection by the sensor due to the PID's poor sensitivity to SP. The odor line was set at 1 LPM and the continuous line was set at 2 LPM. This produced a 33% air dilution, as in training. The continuous airline was on during the odor clearance period.

Solid-Phase Microextraction Followed by Gas Chromatography-Mass Spectrometry Sampling of Smokeless Powder.

To identify the SP target odorant directly from the olfactometer, diphenylamine was selected as the detectable signature of SP due to is abundant presence in the headspace of directly sampled SP using solid-phase microextraction followed by gas chromatography-mass spectrometry (SPME-GC/MS). Prior to the start of sampling, SP was allowed to equilibrate within an odor vial connected to the olfactometer for at least 1 h. Next, the output line of the olfactometer was connected to a clean glass VOC collection vial (236.5 ml), which was pierced with two needles, the first of which was connected to the olfactometer and the second to vent the air pressure to prevent damage to the collection vial. The olfactometer was activated for 30 s at an airflow ratio of 2:1 (2 l/min of clean air with 1 l/min of odor). To prevent the loss of the collected odor volatiles, the airflow needles were immediately removed, and the odor collection vial immediately scaled with parafilm. A polyacrylate (PA) SPME fiber (Supelco, Sigma Aldrich) was then inserted to the collection vial headspace for an optimized extraction time of 3 h, for a total of six replicates.

To validate odorant clearance in the olfactometer line, blank samplings were conducted to determine if any potential contamination existed between trials. Variations of length of tubing, from 1 ft (short line) to 3 ft (long line), were tested as was the application of heat tape to the shorter line (short line with heat tape) to evaluate if added heat could reduce any potential contaminants present in the system. Six replicates were performed for each variation of the blank sampling trials. In each experiment, 40-ml glass SPME vials with a screw cap and PTFE/silicone septa (Supelco, Sigma Aldrich) were used. For olfactometer testing, 10 g of double-base smokeless powder (H335 rifle powder obtained from Hodgdon Powder Company) was used as the odor sample, and an empty sterile vial was used for the blank odor collection.

A 40-ml odor collection vial was pierced with two needles, the first of which was connected to the olfactometer and the second to vent the air pressure to prevent damage to the collection vial. The sample vial containing the smokeless powder was activated for 30 s at an airflow ratio of 2:1 (2 l/min of air with 1 l/min of odor), and this odor was not collected. Another 30-s interval was allowed to pass to mimic the “clearing” time between canine searches. At the conclusion of the 30-s clearing interval, the sterile empty vial was activated for another 30-s interval. This blank sample was collected in the 40-ml collection vial. The airflow needles were removed, and the odor collection vial immediately sealed with parafilm. The SPME fibers were then inserted for a 3-h extraction period. Upon completion of the 3-h extraction time, the fibers were run with the established gas chromatography-mass spectrometry (GC/MS) method to analyze any potential contaminants that may be carried over from the active odor vial and to confirm that the target odorant, diphenylamine, was not remaining in the olfactometer between active trials.

GC/MS was used as the confirmatory technique for the presence of the target odor volatile in the headspace of all collected samples. An Agilent Technologies GC 7890A with an Agilent Technologies 5975C inert XL MSD with triple-axis detector (Agilent Technologies, Santa Clara, CA) was used to separate and analyze the compounds extracted on the SPME fibers. A Rt×R−5 capillary 30 m×250 μm×0.25 μm column (Restek Corporation, Bellefonte, PA, USA) was used. Helium was used as a carrier gas at a flow rate of 1.0 ml/min. The temperature ramp was programmed from 40° C. to 280° C. beginning with a 1-min hold at 40° C. and then increasing the temperature to 200° C. at 15° C./min with a 1-min hold at 200° C. The temperature was then increased to 240° C. at 15° C./min and held for 6.50 min at that temperature. From 240° C., the temperature was increased at 25° C./min to 270° C. The final temperature of 280° C. was reached by ramping the temperature at 5° C./min and holding for 4 min. The injector temperature was set at 280° C. in split mode at a split ratio of 5:1.

The total run time for analysis was 29.033 min. Mass spectra were repeatedly scanned from 45 to 550 amu. Target compound was identified using the National Institute of Standards and Technology (NIST) (2017) mass spectral reference library and verified with external standard calibration. The criteria for the compounds identified were those with detected peaks greater than or equal to a match quality of 90% or above.

Data Analysis. By using IR beam sensors in front of each port, the apparatus had the capability to automatically measure and record the latency to search, the number of times a dog searched a port (port entries), the amount of time the dog sniffed each port (sniff time), a timeout, and dogs' response during each trial. The inventors evaluated dogs' performance progress daily. If a dog received two training sessions in a day, the performance of both sessions was averaged to calculate their daily performance. If a dog received only one session in a day, the performance of that session was used as their daily performance. No null hypothesis testing was conducted, as the aim is to describe dogs' progression during training. The cumulative sniffing time was calculated by adding the amount of time a dog sniffed each port during a trial. The 4-s nose hold from an alert was not included as part of the sniffing time. In the same way, the cumulative number of port entries was calculated by adding the number of times a dog searched each port during a trial. Latency was defined as the time from the beginning of the trial until the dog initially searched any port. A correct response was noted if a dog alerted to the port containing the target odor or did an all clear during a blank trial in phase 3. A false alert was noted when the dog alerted to a port containing a distractor or to a blank trial. If a dog did not alert to the target odor after sampling all three ports, the response was noted as a miss.

To visualize the signal of the PID, the raw voltage readings were filtered with a low-pass Butterworth filter at a scalar of 0.05 of the Nyquist frequency using the signal package of R (21). To address sensor drift of the voltage readings (observed decreases in baseline values across time) of the PID, the inventors used the mean voltage reading of the 30 s prior to odor activation (between activation times) as an offset value that was added equivalently to both the odor “off” and odor “on” values for that odor cycle. The signal from the olfactometer microcontroller was overlaid to visualize odor activation periods to enhance visualization.

All GC/MS data was analyzed using ChemStation software (Agilent Technologies, Santa Clara, CA). Compounds known to be products of the column or sampling process were not included in the analysis.

All statistics were calculated using SAS 9.4 and R studio statistical software.

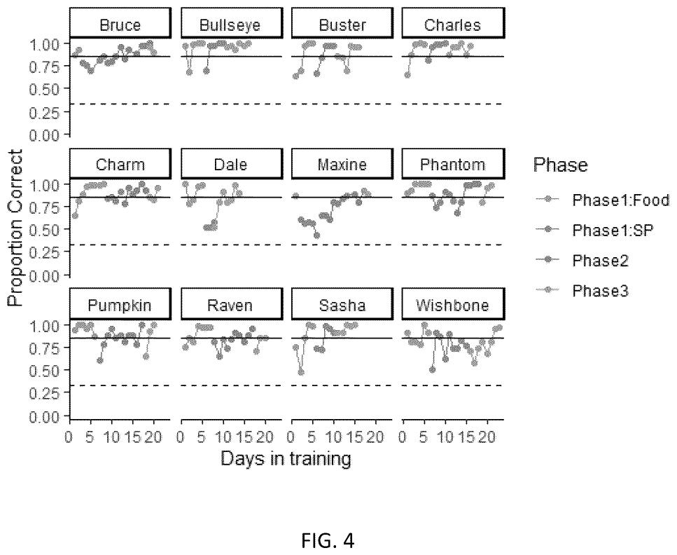

It was found that all 12 dogs presumably naïve to odor detection training learned to operate the equipment and successfully detected SP at accuracy rates exceeding 85% correct responses within 23 days of training. FIG. 4 highlights the training progression of each dog through the different training phases: each dog's proportion of correct responses through the different training phases. A dashed line indicates 0.33 proportion correct responses (performance at chance levels). A solid line indicates 0.85 correct responses (training criterion). All dogs completed training and performed at the olfactometer above training criterion within 23 days in training. Dogs initially were trained using food odor (hotdog) to promote spontaneous interest in search. Next, dogs were transitioned to the target odor smokeless powder (SP). In phase 2, testing was conducted double blind, and trial termination occurred for incorrect responses. In phase 3, blank trials (no target odor present and dogs had to clear all three ports) were introduced at a frequency of 10%. On average, dogs completed the training criterion of phase 1: food in 5.25±0.59 days (7.91±0.80 training sessions). It is important to note that, dogs in the first cohort received some initial training with SP, before starting training with food as the inventors were uncertain and developing the training methods at the time. It was noticed that they were not progressing in training with SP, as such, the inventors decided to implement the initial training with a biologically relevant odor (phase 1: food). Thus, Bruce and Maxine learned the task with the hotdog in only 2 and 1 day, respectively, as they were already familiarized with the equipment. Nevertheless, the rest of the dogs in the first cohort spent similar or even more time in this phase compared to dogs in the second cohort, which only received phase 1: food training. This may suggest that the initial SP exposure had little to no effect accelerating training in most of the dogs. After training with hotdogs, most dogs transitioned to SP without issue. Phantom, Raven, Maxine, and Wishbone each required some return to phase 1: food training during the transition phase. Return to phase 1: food consisted of giving dogs 10 trials with hotdog as the target odor before starting the session with SP to initiate search with the apparatus. On average, within 5.25±0.42 days (8.75±0.70 training sessions), the nose hold alert criterion was increased to 4 s.

Dogs in the first cohort completed phase 2 training in 7.66±1.08 days (8.83±1.22 training sessions). After phase 1: SP training, the second cohort of dogs was transitioned directly to phase 3. It was decided to skip phase 2 with the second cohort based on their performance and trainer experience with the first cohort. After 4.41±0.55 days (4.83±0.73 training sessions) in phase 3, most dogs reached the training criterion of detecting SP at an accuracy >85% with a nose hold of 4 s and a target odor prevalence of 90% of the trials. All dogs met an 85% training criterion during the last two sessions in phase 3 as shown in Table 2, and most reached an accuracy >90% in their final two sessions, with the highest performing dogs reaching 98.75% accuracy (79 correct responses out of 80 trials).

TABLE 2

| Dog | Overall accuracy, % |
|---|---|
| Bruce | 92.50 ± 2.5 |
| Bullseye | 98.75 ± 1.25 |
| Buster | 95.00 ± 0.00 |
| Charles | 92.5 ± 5.00 |
| Charm | 87.50 ± 3.82 |
| Dale | 93.75 ± 3.75 |
| Maxine | 90.00 ± 2.50 |
| Phantom | 87.50 ± 7.50 |
| Pumpkin | 96.25 ± 3.75 |
| Raven | 85.00 ± 0.00 |
| Sasha | 98.75 ± 1.25 |
| Wishbone | 95.83 ± 1.39 |

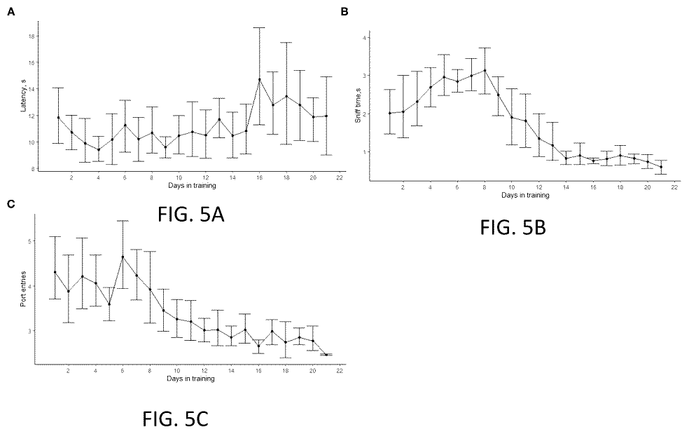

FIGS. 5A, 5B, and 5C show how the latency to search, the number of port entries, and the sniff time changed as training progressed. The dots show the mean, and error bars show the 95% confidence interval. The average search latency did not significantly change with time (FIG. 5A). The cumulative sniffing time (FIG. 5B) and the cumulative number of port entries within a trial (FIG. 5C) decreased with training. This indicates that, as training progressed, dogs were more efficient and were able to detect the target odor more easily. On average, the latency to search slightly increased after 15 days in training (FIG. 5A). This was the time when most dogs were introduced to phase 3. Overall, the average latency to search was 11.05+0.24 s. The number of port entries and the sniffing time reduced with training (FIGS. 5B and 5C). At the beginning of the training, the cumulative sniff time (excluding the nose hold required for an alert) was 2.14+0.94 s, and it decreased to <1 s at the end of phase 3. Similarly, the average number of port entries within a trial gradually reduced from more than four at the beginning of training to 2.67+0.05 at the end of phase 3.

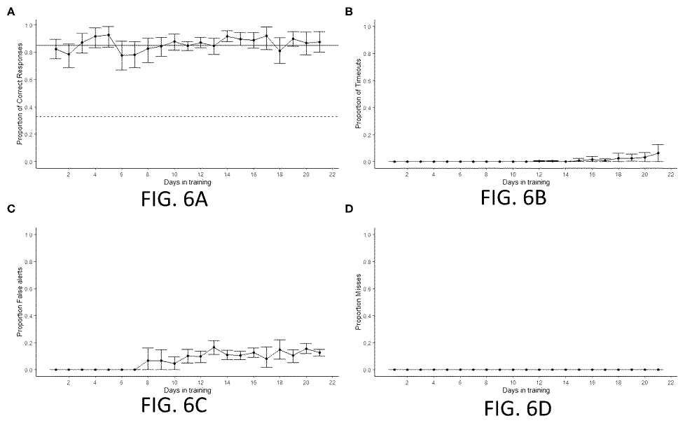

FIGS. 6A, 6B, 6C, and 6D show dogs' (N=12) detection performance in the line-up olfactometer during the first 21 days of training. The dots show the mean and error bars show the 95% confidence interval. (FIG. 6A) Dashed line shows chance (0.33) performance and the solid line the training criterion (0.85). Proportion of correct responses was always above criterion within five training sessions. A slight reduction in the proportion of correct responses was observed at day 6. This was the time when most dogs transitioned to smokeless powder (SP). Performance with SP recovered to above criterion levels within four training days. No timeouts were observed until day 15 when most dogs started phase 3, where blank trials were introduced (FIG. 6B). The transition to SP as the target odor from hotdog increased the number of false alerts at day 8, and this continued throughout the remaining of the training (FIG. 6C). No misses were recorded (FIG. 6D). The overall proportion of correct responses increased above 0.85 by day 3 in training with hotdog as the target odor (FIG. 6A). As dogs transitioned to SP, the proportion of correct responses slightly decreased, but overall, the average performance surpassed 0.85 within 4 days of training with SP. All dogs showed a mean performance above the training criterion during phase 3 (days >15), which involved double-blind testing and 10% of the trials as blank trials (dog was required to clear all three ports that did not contain the target). No timeouts were recorded until day 15 (FIG. 6B). This was when blank trials (phase 3) were introduced for most of the dogs and because during the initial training a trial did not have a specified termination time. Dogs did not false alert during the training with hotdogs (FIG. 6C). Once SP was introduced, the proportion of false alerts increased, but it never averaged more than 20%. Maxine and Dale were the only two dogs that showed a proportion of false alerts >0.20 when introduced to SP training. Because of this, they were moved to training phases 2 and 3 faster than other dogs to penalize (no reinforcement) false alerts and promote correct responses. No misses were recorded during training (FIG. 6D). This means that incorrect responses were only due to false alerts or timeouts (failure to sample the target port).

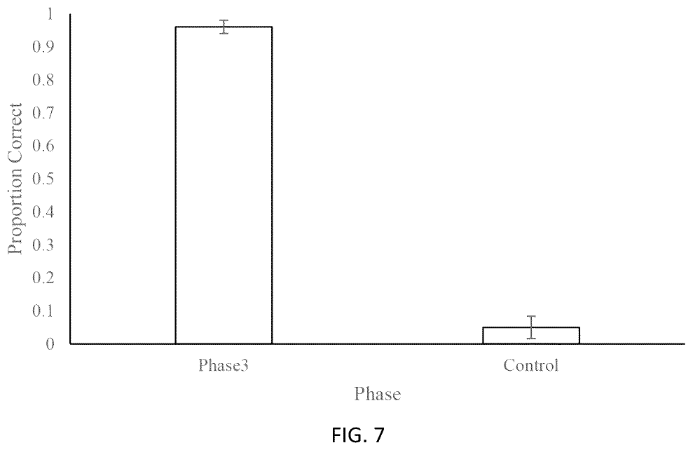

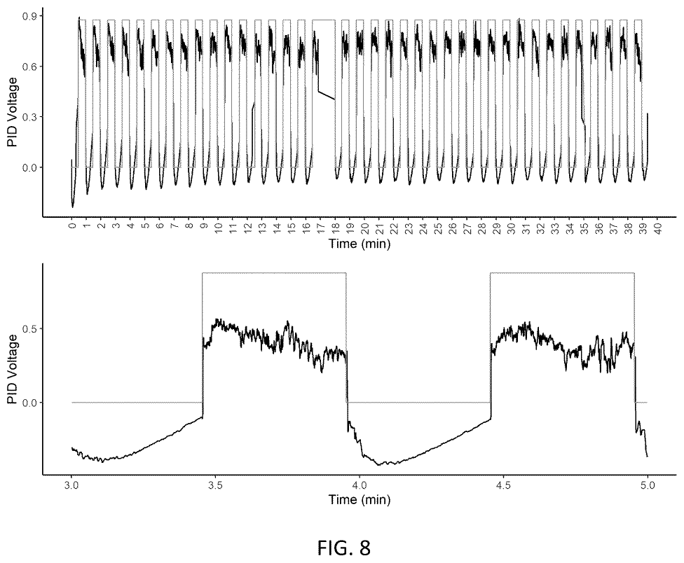

Overall performance on the control session (odorants not connected but valve activated) was poor (5.00%±3.37%) and well below that expected by chance (33%), indicating that dogs were indeed following odor cues to identify the correct odor port (FIG. 7). The control test consisted of 10 trials where the odor line was disconnected from the olfactometer. This shows that the dogs' performance was mediated by the presence of the odor and not by unintentional cues from the equipment or the handler.

The PID was able to detect the odor immediately after the activation of the odor valve and was relatively stable over nearly 40 min of stimulation (see FIG. 8). FIG. 7 shows that odor signal was closely related to olfactometer stimulation (red square wave). Note, one packet of data was dropped from the DAQ between minute 17 and 18. The bottom panel of FIG. 7 shows a focused view of two stimulations, highlighting the odor was rapidly detected at the odor port and rapidly cleared from the port with limonene as the tracer odorant.

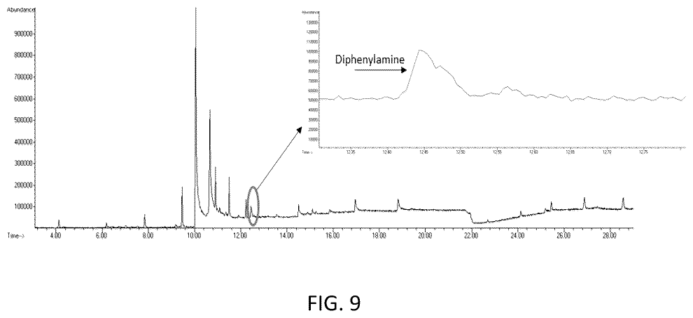

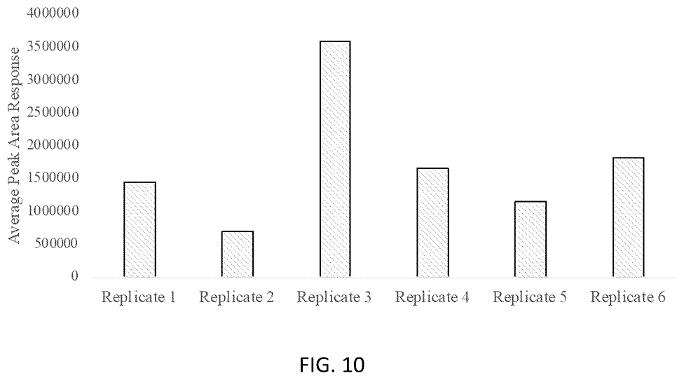

A total ion chromatogram of the SPME-GC/MS analysis is shown in FIG. 8 for detection of volatiles associated with the smokeless powder target directly. The top figure shows the olfactometer stimulation over a 40-min period. Note at 17 min, a data packet loss from the DAQ occurred. The black line shows the PID voltage. The red line (square wave) shows the olfactometer stimulation (valve on). The bottom figure shows an enlarged view of two representative stimulations. As seen in FIG. 9, the polyacrylate (PA) fiber yielded successful detection of diphenylamine, a target volatile associated with smokeless powder. Diphenylamine was detected in all six of the replicates with an average peak area response of 1,734,916±370,022 (SE) (see FIG. 10).

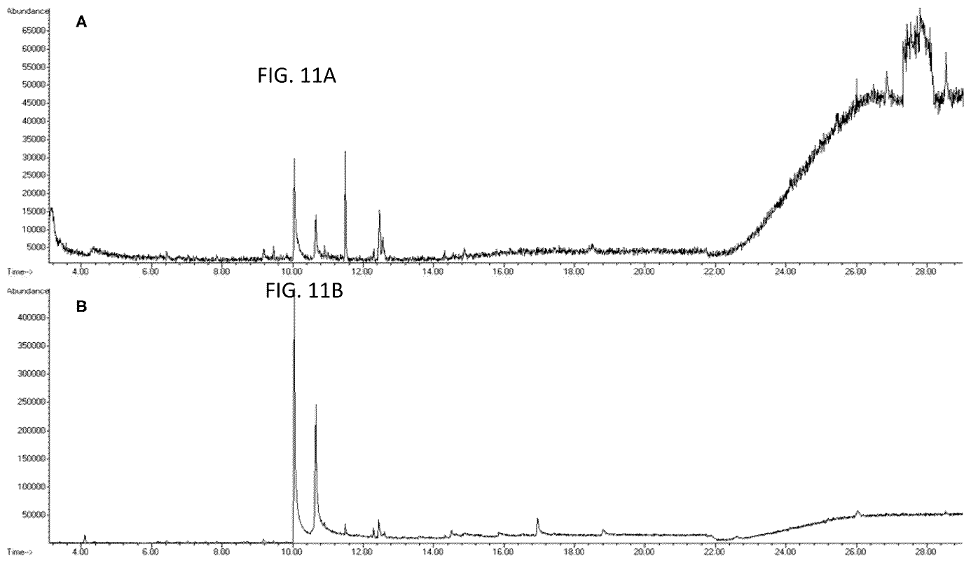

A total of 18 replicate samples were tested to verify odorant absence from the olfactometer between odor trials. Variations of length of tubing, from 0.30 m (short line) to 0.90 m (long line), were tested, as was the application of heat tape to the shorter line (short line with heat tape) to evaluate if added heat could reduce any potential contaminants present in the system. Six replicates were performed for each variation. Instrumental results did not detect diphenylamine in any of the 18 samples tested. FIGS. 11A and 11B depict the total ion chromatograms for blank runs extracted before and after odorant purge through the system. FIG. 11A shows a pre-powder purge. FIG. 11B shows a post-powder purge. All shown peaks are attributed to column or environmental background noise.

Results indicate that only background and column-associated molecules were detected and confirm that there is no detectable carryover or contamination between trials with diphenylamine, suggesting complete removal of the smokeless powder target is achieved within the olfactometer line.

All dogs, presumably naïve to scent detection work, were able to learn and operate the line-up in less than a month. This indicates that the line-up was simple to operate and that dogs can progress through the outlined training method easily. Since the dogs used were in a train-for-adoption program, working and pet dogs can also learn to operate the apparatus with similar case. The simplicity of the method is an advantage over other automated systems available. For instance, after screening 12 dogs, only five were trained to perform an automated scent wheel (1). The fact that all 12 participant dogs were able to reach the training criterion is a good indication that most dogs can learn to operate the system.

Traditional scent detection work usually requires extensive training periods. Long training periods are one of the factors that limit the number of subjects that participate in research, as it requires a significant amount of time and resources for each participant to be trained. In a systemic literature review, Johnen et al. (22) found that the average number of participant dogs in detection studies was 4.6+3.2, ranging from one to 10, and that most studies had a training period of over 2 months. The automated line-up system developed herein helps researchers increase the number of participant dogs in their studies, as this system requires significantly less training time (less than a month) as it is easy to learn by dogs.

In addition, the automated olfactometer reduces labor. Traditional line-up procedures require researchers to spend a considerable amount of time preparing the sessions ahead of time (e.g., odor preparation, randomization of odor trials, preparing data sheet, etc.) and collecting the data manually during the session or after by coding the recordings. The computer program developed automated all these tasks, significantly reducing the amount of time and effort needed to prepare and run a testing session and to collect the data. In addition, because every trial is generated by the olfactometer program, the system always ensures double-blinded testing. This is another benefit of the apparatus, as it reduces the chances of a dog using unintentional cues from the experimenter (4, 8) (Clever Hans effect). By always ensuring double-blinded conditions, the apparatus increases data reliability as the experimenter can be confident that dogs' performance is not unintentionally biased. For instance, Elliker et al. (23) highlight the importance of double-blind testing in detection dogs as the lack of a robust double-blind testing could lead to erroneous conclusions about dogs' performance. In their experiment, they found that dogs were not able to generalize to new cancer-positive samples during a double-blind testing (23). This suggested that dogs were not alerting to a common cancer odor.

The results from a control test show that dogs in the olfactometer were exclusively using odor to make a correct alert, as their performance dropped when the odor vials were not connected to the olfactometer. Because the olfactometer always allows double-blind testing and has incredible odor stimuli control, it is an ideal research instrument to study generalization and/or evaluate if the dogs are solely using a specific odor to alert and confirm that the phenomenon observed by Elliker et al. (23) is not happening. The olfactometer is a great tool to quickly detect similar problems early in training to prevent researchers from concluding that dogs are alerting to a specific target odor when in reality they are not.

The use of this apparatus significantly increased the amount of data collected from each dog. For instance, on average, each 40-trial session took 30 min or less. In a traditional laboratory line-up model, dogs receive <10 testing trials in a day (22, 24, 25). Johnen et al. (22) reported that only two of the 14 papers reviewed had more than 30 testing replicates, and both studies had a data collection period of over a month. Herein, the inventors collected data for 480 trials per day (e.g., one training session for 12 dogs will take 6-8 h). The capability of increasing the amount of data collection is extremely beneficial to detection dog research as it increases the power of experiments, especially when few participants are used. By significantly increasing the number of trials (“searches”), the apparatus also increases the precision of the variables estimated within a session and/or individual dog.

The apparatus also increased the resolution of the data collected. Using infrared sensors, the apparatus was able to measure not only the amount of port entries but also the exact duration of a nose hold. For instance, the cumulative sniffing time (sum of the amount of time a dog sniffs each port) at the end of training was <1 s. This indicates that a dog sniffed each port for <0.50 s on average. Measuring this would have been extremely difficult by a human observer even when watching video recordings of the sessions. The automated system also provided an objective evaluation of dogs' responses. By using the infrared sensors, the apparatus reduced human error when recording an alert and potential variability between observers (e.g., an observer counts four seconds faster than other) as the 4-s nose hold is always read by the sensor. This provides researchers with an objective and unbiased way to call and record dogs' alerts.

The odor validation data showed how the olfactometer provided an optimal control on the odor stimuli presented. The results showed that immediately after the valve was activated, the odor was detected in the port. Thus, there was no delay in odor presentation. Similarly, the odor signal returned to baseline immediately after the odor valve was closed. After 40 consecutive 30-s odor on/off cycles, the odor signal remained detectable by the PID. The maximum number of times an odorant could be presented by an olfactometer (the system has three olfactometers) within a session was 13-14 times, indicating that there is good odor stability across a session.

Use of the smokeless powder target, SPME-GC/MS analysis showed variability in diphenylamine concentrations across replicates (although it was always present). Peak areas fluctuated across the replicate samplings, suggesting airflow introduction as a possible factor for lack of response reproducibility. Another factor for peak area fluctuation can be related to the dynamic chemistry of smokeless powder, which can affect detection of odor volatiles. Diphenylamine is a stabilizer that may interact with nitrocellulose or nitroglycerin when allowed to stand, thus affecting the overall powder composition at any given moment. The original powder-manufacturing process and environmental conditions determine how each of these is incorporated into powder. These reactions can yield to stabilizers degrading into nitrogenous products not readily detected by the employed methodology (26). However, it should be noted that even with repetitive sampling occurrences, target odor volatile was still detectable for all replicates within instrumental limits.

During training, each session was conducted 5-10 min apart from each other, and the inventors did not notice detection issues reflected in canine performance. However, the skilled artisan will recognize that odor dynamics are different for each odorant. Factors such as the concentration of the solution, vapor pressure, and the partition coefficient can be adjusted to change the odor dynamics on the olfactometer. Thus, an odor validation test should be conducted for each target odor tested.

It was found that all dogs readily learned to operate the apparatus and search in a line-up manner to alert to a relevant target odorant (smokeless powder). By the end of the training, most dogs achieved overall accuracy levels >90%. All dogs were successfully trained with a 15-23-day window, indicating the apparatus is an efficient tool for training new detection tasks. The device also allowed us to conduct numerous trials per day efficiently while conducting all trials double blind. Control trials further revealed that dogs were utilizing odor cues and not unintentional cues of the system. Instrumental validation verified target odorant detection and confirmed clearance of odor stimuli from device when no odor was in use. Altogether, it was found that that the automated line-up is a useful laboratory equipment for measuring dogs' olfactory performance.

The developed automated system is a valuable tool to enhance and improve detection dog olfactory research.

Any and all aspects of embodiments of the present invention disclosed herein are disclosed to be present together in any single embodiment unless prevented by physical impossibility.

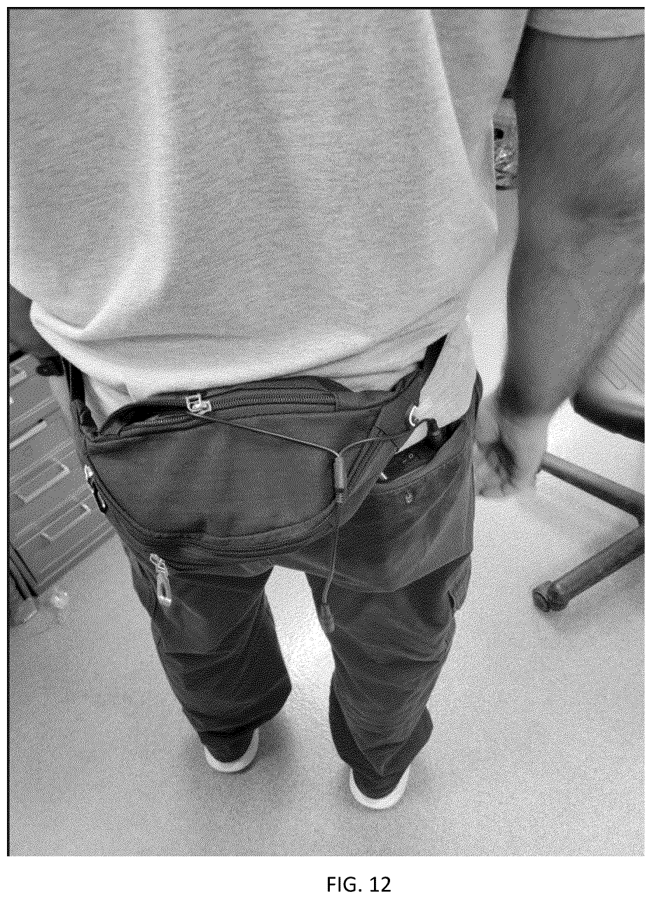

FIG. 12 shows an image of an apparatus for remotely controlling one or more olfactometers of the present invention. In embodiments of the present invention, one or more olfactometers can be remotely controlled, including by long range radio. In embodiments of the present invention, the system for training detection dogs is portable.

Prior work has demonstrated canine search behavior and performance declines when challenged with infrequent target odors. The purpose of this study was to evaluate whether performance could be maintained in a low target odor prevalence context by explicitly training dogs through progressively leaner target odor schedules. In Experiment 1, nine control dogs were trained at 90% target prevalence rate. Nine experimental dogs were trained with progressively lower prevalence rates in 10% increments until reaching 20% prevalence with >85% detection accuracy in the training context. Both groups were tested in the operational context at a 10% target odor prevalence. Experimental dogs had higher accuracy, hit percentage, and shorter search latency in the operational context compared with control dogs. In Experiment 2, twenty-three operational dogs were challenged with a target frequency of 10%, which resulted in 67% accuracy. Control dogs were then trained with 90% target frequency, whereas experimental dogs received a progressively decreasing target rate from 90% to 20%. The dogs were rechallenged with target frequencies of 10, 5, and 0%. Experimental dogs outperformed control dogs (93% vs. 82% accuracy) highlighting the effect of explicit training for infrequent targets. Experiments 1 and 2 were conducted using embodiments of the present invention as disclosed herein.

Dogs are trained for the detection of a wide range of materials such as explosives, narcotics, ignitable liquids (Abel et al., 2020; Jezierski et al., 2014; Maclean & Hare, 2018; Marks, 2002) providing critical detection capabilities for national security. Similar to a wide range of human safety workers, dogs are routinely asked to search in specific environments (i.e., airports, cargo shipments, or stadiums) for long durations, where the probability of finding a true target can be exceedingly low.

Prior research has demonstrated that dogs can be highly sensitive to contexts that are indicative of a low probability of encountering a target stimulus. For example, Gazit et al. (2005) led explosives detection dogs to search along two distinct paths (A and B). Along Path A, five targets were present, whereas Path B had no targets present (Gazit et al., 2005). The dogs quickly showed reduced search along Path B such that when explosives were hidden along this path, the dogs showed a substantial reduction in detection. Furthermore, Porritt et al. (2015) found similar results where a group of dogs that repeatedly searched an area with no target odors showed a substantial search decrement and detection in those areas. Most recently our lab has developed a laboratory model of this effect (Aviles-Rosa et al., 2023) using automated olfactometer equipment. Dogs showed substantial decrement (i.e., accuracy and search performance behavior) when the prevalence of the target odor was rapidly reduced from 90% in a training context to 10% in a simulated “operational” context. Together, these results suggests that dogs can be acutely sensitive to the prevalence rate of the target odor in the search environment and that low target odor frequency in the search environment leads to a decrement in search behaviors and detection performance.

One suggestion to mitigate this decrement in performance was from a follow up study by Porritt et al. (2015), where the authors trained dogs to indicate to a nonexplosive, innocuous odor. When this innocuous odor was placed in the search path with no other explosives, the dogs' performance improved and was sufficient to maintain search behavior (Porritt et al., 2015). These results suggest that to improve dogs' detection performance, at least occasional reinforced targets are needed, which can be done via increased prevalence of target odors or by planting an innocuous odor in the search environment. However, providing operational finds to the dogs at a frequency sufficient to maintain search behavior may not always be feasible due to logistical and safety reasons.

Basic laboratory research on behavioral persistence under extinction conditions suggests that training with intermittent schedules of reinforcement leads to greater resistance to extinction (partial reinforcement effect; Chan & Harris, 2019; Harris et al., 2019; Haselgrove et al., 2004; Lewis, 1960; Nevin, 1988). Importantly, this effect seems to be maintained by animals learning about the presence of nonreinforced trials (Harris et al., 2019; Haselgrove et al., 2004) such that learning the presence of nonreinforced trials helps maintain responding when the animal is not reinforced under extinction or near-extinction conditions. This behavioral principle can be applied to detection dogs in an attempt to maintain search behavior in contexts with low target odor frequencies that resemble extinction procedures.

Detection dog behavior can be considered a behavior chain with two links. A discriminative stimulus evokes trained search behavior, leading to the appearance of a target odor. The target odor serves as a conditioned reinforcer for the search behavior and as a discriminative stimulus to occasion an alert behavior, which is reinforced with the terminal reinforcer (food or toy). When the search behavior is not reinforced with the presence of a target odor, search behavior and performance decreases (e.g., Aviles-Rosa et al., in press; DeChant et al., in press, Parts I and II this issue; Gazit et al., 2005; Porritt et al., 2015). Previous work in rodents on the use of intermittent schedules of reinforcement on resistance to extinction (Chan & Harris, 2019; Harris et al., 2019; Haselgrove et al., 2004) suggests that when applied to detection dogs, training dogs with an intermittent schedule of reinforcement (e.g., training with an odor frequency similar to what may be anticipated in an operational scenario) may improve performance.

Recent work in rodents developed an analog model for working dogs in which rodents had to manipulate one object (lever or chain) to simulate a dog's “search” behavior followed by making another response to simulate a dog's “alert” behavior (Thrailkill et al., 2016). This study found that intermittent reinforcement of the simulated search behavior (compared with continuous reinforcement) led to greater resistance to extinction of the search behavior. This finding further suggests that training dogs with a more intermittent frequency of target odor may lead to greater resistance to extinction in operational contexts.

Producing intermittent odor frequency for detection dog search can be accomplished by including higher frequencies of “blank” trials. A blank trial is a trial in which only distractor odors are available and the target odor is not presented. Interestingly, despite previous work suggesting that intermittent reinforcement (or higher frequency of blank trials) may help with dogs' persistence in operational conditions, this does not seem to be a standard training practice. Recent work from DeChant et al. (2020) included a survey of the typical practices of law enforcement/professional canine handlers and hobby/sport canine handlers. A total of 38 law enforcement/professional handlers participated. Although 95% of handlers reported training their dogs once a week or more frequently, 75% of handlers reported running one or fewer blank runs during training sessions (DeChant et al., 2020). Further, 45% of handlers reported running fewer than one blank run per training session, and 13% never conducted a blank run. Given that this practice conflicts with the preliminary scientific evidence, an important next step is to evaluate whether increasing the frequency of blank trials during training of dogs searching for an operationally relevant odor leads to increased resistance to search extinction and overall better performance in a simulated operational test. The purpose of this study was to evaluate whether detection performance could be maintained in a low-target-odor-prevalence context by explicitly training dogs through a progressively leaner schedule of targets. Experiment 1 first established this effect in a laboratory model and Experiment 2 replicated and extended this work in operationally deployed detection canines.

Effect of intermittent odor prevalence training on detection performance in a laboratory model.

Animals. Eighteen mixed-breed dogs (the same dogs used in Parts I and II of this issue, split into three different cohorts of six dogs each) were used and housed at the Texas Tech University (TTU) Canine Olfaction Lab and were participating in a training program to increase adoptability. The dogs' backgrounds were unknown, but all were presumably naïve to detection training when first brought to TTU and showed adequate detection capabilities in Parts I (Aviles-Rosa et al., in press) and II (DeChant et al., in press) of this series. The dogs received twice daily walks, social enrichment, and training for adoption. All procedures used in both experiments were reviewed and approved by TTU Institutional Animal Care and Use Committee (IACUC #19093-10).

Apparatus and general procedures. The dogs were trained to operate the three-alternative choice automated olfactometer system described by Aviles-Rosa et al. (2021) in two different rooms or “contexts.” These rooms were adjacent (shared a common wall) and were identical in size but were mirror images from a birds-eye view such that Room I had a door in the top right corner, with training equipment in the bottom left, whereas Room 2 had a door in the top left corner, with training equipment in the bottom right of the room. These rooms are referred to as the training and operational context, respectively. These two contexts model how dogs are frequently trained in one area but operationally work in another area. Cohorts 1 and 3 had the same room assignment for operational and training contexts; however, Cohort 2 had the opposite room assignment for the context (i.e., the training context for Cohort 2 was the operational context for Cohorts 1 and 3).

At the start of each session, an experimenter brought the dog into the appropriate room and the dog worked off leash independently of the experimenter. The experimenter was always blind to the position of the odorants (and presence of the target odor) in the odor ports.

The dogs were trained to detect and alert to the odor of double-based smokeless powder (SP), which is a propellant that most explosive detection dogs are trained to detect. In addition, there were five different distractor odors (cotton gauze, plastic gloves, blank jar, limonene (-) 10⁻³ v/v dilution in mineral oil, and mineral oil). These distractors were chosen based on typical items an operational dog may encounter, items generally used in the laboratory (i.e., gloves), and another odorant (i.e., limonene) that served as a novel strong odor.

At the start of every trial, all three olfactometers were activated to present an odor to its respective odor port. If the target odor was programmed to appear for that trial, the port in which it would appear was determined pseudo randomly such that it appeared approximately equally in all three ports within a session. If a target was not programmed to appear, all three olfactometers would present one of the five distractor odors. If an olfactometer was not programmed to present a target, the distractor odor was selected at random from a uniform distribution with equal probability of each distractor. Distractor selection occurred independently for each olfactometer; thus, the same distractor could appear in multiple ports within the same trial.

Once all three olfactometers were activated, a panel that covered the three odor ports was raised by the computer. At this point, the handler would tell the dog to “search.” Infrared beams measured each nose entry to all three odor ports. Dogs were required to make a 4-s continuous nose hold as an “alert” response. If no target odor was present, dogs were trained to make an “all-clear” response by investigating all three ports and then removing their nose from the apparatus for four consecutive seconds. The first response, an alert or all clear, immediately terminated the trial, which led to the panel cover lowering to cover the odor ports. The olfactometers then activated an odor purge and an odor exhaust evacuated odor out of the room for the 20-s intertrial interval (ITI). If a dog did not make a response (an alert or an all clear) within 45 s of the trial start, typically by failing to search any or all three of the ports, the trial was terminated and scored as a “timeout.” Scoring of all responses was done by the computer via the infrared beam detection of nose entries to each port. If the dog made a correct alert to the port presenting the target, the computer sounded a “correct” tone and triggered an automated feeder. If the dog made an incorrect alert (i.e., a false alert), the trial terminated and the panel lowered, covering the odor ports, and the computer initiated the ITI. If a dog made a correct all-clear response, the panel lowered and the computer initiated the ITI. These responses were not reinforced to mimic how detection dogs typically continue searching after clearing an area without targets and when no reinforcers are delivered. If a dog made an all-clear response when a target was present, the panel was lowered and the ITI started (similar to an operational setting if an unknown target is missed). Table 3 summarizes the various trial outcomes and measures of performance.

TABLE 3
Measures of performance Experimental design

| Measurement | Definition | Calculation |
|---|---|---|
| Overall | Dog alerted to the correct port during | (Number of correct responses/40 |
| accuracy, % | an odor trial or did a correct all | trials) × 100 |
| | clear during a blank trial. | |
| False | Dog alerted to the incorrect port on | (Number of false alerts/40 trials) × |
| alerts, % | any trial (odor or blank) | 100 |
| Timeout, % | Dog did not search all three ports or | (Number of timeouts/40 trials) × |
| | make a response within 45 seconds | 100 |
| | after the trial started | |
| Hits, % | Dog alert to the odor correctly on an | (Number of correct responses to odor/ |
| | odor present trial. | number of odor trials) × 100 |
| Correct | Dogs made a correct all clear during | (Number of correct all clears/number |
| rejections, % | a blank trial. | of blank trials) × 100 |
| False all | Dog response was an all clear after | (Number of false all clears after the |
| clears, % | sampling the port containing the | dog sampled all ports during an odor |
| | target odor | trial/number of odor trials the dog |
| | | sampled all ports) × 100 |
| Latency, s | Time required for a dog to search at | (Σ Latency/40) |
| | least one port after a trial started. | |
| | If the dog did not search during a | |
| | trial the trial latency was 45 s. | |

Baseline period. All dogs started in a baseline period that consisted of four 40-trial sessions in both the operational and training contexts at a 90% odor prevalence rate (e.g., 10% of the trials were blanks/distractors). The dogs then entered either an experimental or control training period. The dogs were randomly assigned either to the control or experimental training based on experimental and control assignments from the preceding study (DeChant et al., in press, Part II). These assignments were maintained for this study. This was done to ensure the control group did not have prior experimental manipulations. Risks of potential experimental carryovers were planned to be addressed in Experiment 2.

Training period. Following the baseline period, each dog received two daily sessions in the training context during the “training period.” The dogs were not trained in the operational context during the training period. This was done to evaluate whether modifying training in the training context could lead to changes in performance in the operational context. The control group dogs (n=9) were trained at a 90% odor prevalence rate for the entire training period (i.e., two sessions per day). This was to reflect a scenario where dogs are exposed only to high odor prevalence rates during training. The experimental group (n=9) had the target odor prevalence rate reduced by 10% after two sessions with an accuracy ≥85%. A criterion of 85% accuracy was selected to be high and statistically well above chance but a readily achievable criterion. The objective of this procedure was to provide the experimental group with a training schedule where the odor prevalence rate was systematically reduced. The experimental group started training at a target odor prevalence of 80% (e.g., 32 out of 40 trials contained a target odor). After two consecutive sessions with accuracy greater than or equal to 85%, the target odor prevalence was reduced by 10% until the target odor prevalence reached 20%. If accuracy was below the 85% training criterion, the dog was trained on the prior target odor prevalence rate until criterion was reached and then the tar-get odor prevalence was reduced. For example, if a dog was below 85% training criterion at 60% target odor prevalence, the dog would be trained again at 70% target odor prevalence until accuracy was at 85% or greater. The dog would then be trained at 10% progressively lower target odor prevalence. Two experimental dogs (Dallas and Pumpkin) needed additional days (Dallas 9 and Pumpkin 8) of training, so one control dog, Jax, was yoked to the number of additional training days (9 days).

Testing period. Following the training period, all dogs received one session in the operational context and one session in the training context per day for 5 days. The operational context target odor prevalence was 10% for both the control and experimental groups. In the training context, the target odor prevalence for the control group was maintained at 90% and maintained at the trained level of 20% for the experimental group.

Statistical analysis. All data were analyzed separately by the three different periods (baseline, training, test). Because no visual or statistically significant differences were observed in the dogs' performance during the baseline or training periods, below the inventors only present the statistical analyses conducted during the test period, which was the most relevant and significant part of the experiment. To assess the effect of training to low odor prevalence rate on dogs' performance, a logistic generalized linear mixed-effect model was fit with an interaction of group (experimental vs. control) and context (operational vs. training), their main effects, a main effect of session number, and a random intercept for each dog. The primary dependent variable was the trial accuracy outcome (1 for correct and 0 for incorrect). An otherwise identical model was fit for the dependent variables of time-outs, hits, false alerts, and false all clears. To assess the effect of training to low odor prevalence rate on latency, an otherwise identical linear model was fit where the dependent variable was the log-transformed latency. Statistical significance of fixed effects was evaluated using the ANOVA function in the car package in R (Fox & Weisberg, 2018). Significant interactions were further analyzed with Tukey-adjusted post hoc tests from the Ismeans package (Lenth, 2016) to assess for differences between groups for each context. The Imer package (Kuznetsova et al., 2017) in R (R version 3.5.1, www.r.project.org; R Core Team, 2018) was used to fit models.

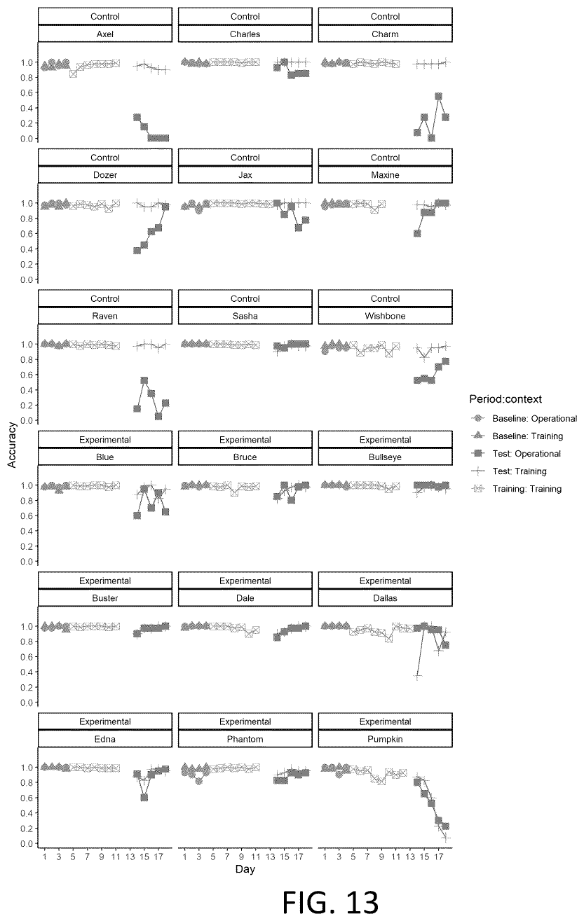

FIG. 13 shows each dog's accuracy (proportion of correct responses that includes hits and correct rejections) by group (experimental and control) during the different periods of the experiment. Specifically, FIG. 13 shows individual dog accuracy (accuracy that includes hits and correct rejections) data for Experiment 1. Each point for the baseline and testing periods summarizes the proportion of correct trials out of 40 trials. For the training period, the day represents the average of two sessions (i.e., 80 trials) in the training context. Experimental dogs showed higher performance in the operational context, suggesting training to lower target odor prevalence had an effect on search decrement and performance. One dog, Pumpkin, was the only experimental dog that did not improve inaccuracy during the test period in operational context. Three control dogs (Sasha, Maxine, Charles) only showed minor decrements in performance in the operational context. Table 4 shows the mean percentage of dogs' accuracy, false alerts, timeouts, hits, correct rejections, false all clears and latency by group, context, and period.

TABLE 4
Mean ± standard deviation of the control and experimental group overall performance
during the baseline, low training, and testing periods during Experiment 1.

| | Period | | | | | |
|---|---|---|---|---|---|---|
| | Baseline | | | | Low training | |
| | Training | | Operational | | Training | |
| Context Group | Control | Experimental | Control | Experimental | Control | Experimental |
| Accuracy, % | 98.05 ± | 99.00 ± | 97.91 ± | 97.96 ± | 97.88 ± | 98.09 ± |
| | 1.63 | 1.20 | 1.76 | 4.26 | 1.98 | 1.86 |
| False alert, % | 00.69 ± | 0.39 ± | 0.69 ± | 0.35 ± | 0.76 ± | 1.11 ± |
| | 1.63 | 0.74 | 1.05 | 0.523 | 1.36 | 1.51 |
| Timeout, % | 0.62 ± | 0.39 ± | 0.90 ± | 1.45 ± | 0.88 ± | 0.682 ± |
| | 0.69 | 0.74 | 1.36 | 3.86 | 1.01 | 5.29 |
| Hit, % | 98.53 ± | 99.14 ± | 98.45 ± | 97.95 ± | 98.33 ± | 99.47 ± |
| | 1.27 | 0.89 | 1.46 | 4.15 | 1.62 | 0.56 |
| Correct | 93.75 ± | 97.65 ± | 93.05 ± | 98.12 ± | 93.78 ± | 96.77 ± |
| rejection, % | 12.10 | 4.65 | 9.60 | 5.30 | 7.56 | 3.57 |
| False all clear, % | 0.69 ± | 0.214 ± | 0.54 ± | 0.25 ± | 0.52 ± | 0.22 ± |
| | 0.92 | 0.33 | 0.77 | 0.50 | 0.60 | 0.37 |
| Latency, s | 5.37 ± | 4.63 ± | 5.66 ± | 5.25 ± | 6.21 ± | 4.65 ± |
| | 1.73 | 2.12 | 1.89 | 3.64 | 2.08 | 2.08 |

TABLE 4
Part 2

| | Period | | | |
|---|---|---|---|---|
| | Test | | | |
| | Training | | Operational | |
| Context Group | Control | Experimental | Control | Experimental |
| Accuracy, % | 97.05 ± 2.53 | 92.56 ± 5.73 | 60.05 ± 33.20 | 90.68 ± 7.34 |
| False alert, % | 1.77 ± 2.04 | 5.56 ± 5.79 | 4.61 ± 4.26 | 2.12 ± 2.58 |
| Timeout, % | 0.44 ± 0.68 | 1.68 ± 1.38 | 35.33 ± 30.49 | 7.12 ± 6.75 |
| Hit, % | 98.20 ± 1.63 | 97.62 ± 2.35 | 71.11 ± 32.86 | 98.12 ± 2.58 |
| Correct | 86.66 ± 15.41 | 90.02 ± 8.84 | 58.82 ± 33.41 | 89.86 ± 8.06 |
| rejection, % | | | | |
| False all | 0.80 ± 0.68 | 0.77 ± 1.79 | 0.0 ± 0.0 | 0.62 ± 1.76 |
| clear, % | | | | |
| Latency, s | 5.31 ± 1.95 | 4.61 ± 1.94 | 17.81 ± 11.47 | 6.08 ± 3.02 |

Note.
Data do not include Pumpkin. Accuracy: Percentage of trials that a dog alerted to the target odor (i.e., hit) or called a correct all clear. False alert: Percentage of trials that a dog alerted to an incorrect port during a target odor or blank trial. Timeout: Percentage of trials that a dog did not alert or search all three odor ports within 45 s. Hit: Percentage of target odor containing trials that a dog alerted to the target odor. Correct rejection: Percentage of trials that did not contain the target odor that dogs did a correct all clear. False all clear: Percentage of trials dogs made an all-clear response on a target odor present trial. Latency: Time (in seconds) it took for the dog insert its nose into one odor port and start the search

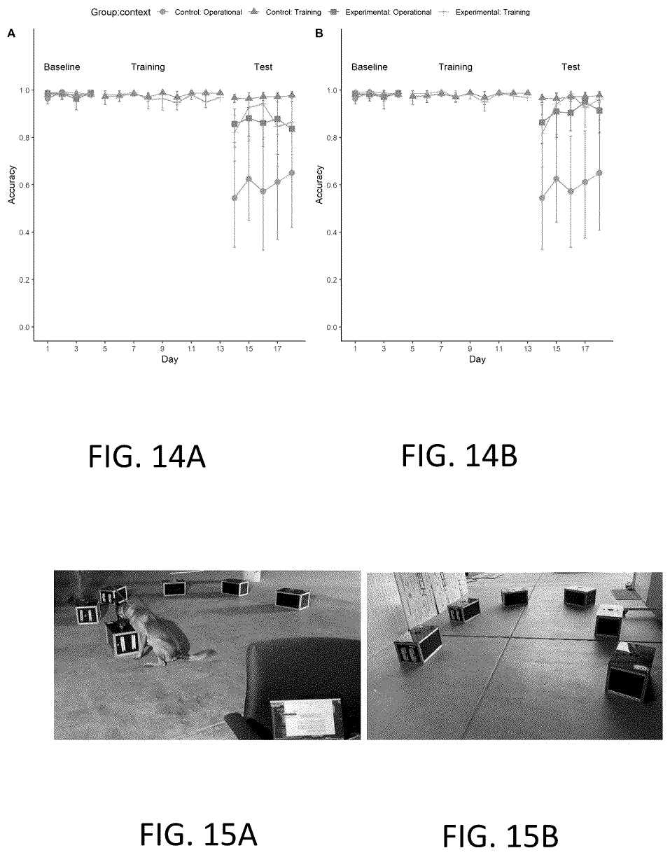

Accuracy. During the testing period, the accuracy for the experimental group was higher (90.68%) than that for the control group (60.05%) in the operational context (see Table 4 and FIG. 14A). FIG. 14A shows the mean accuracy by group for Experiment 1 with all dogs included. Error bars represent 95% confidence interval of the proportion of trials that resulted in a correct response during Experiment 1. The experimental group maintained accuracy near the training criterion, except for the fifth day when it dropped, which was driven by one dog, Pumpkin, in the experimental group. FIG. 14B shows the mean accuracy by group for Experiment 1, excluding Pumpkin from the experimental group. Error bars represent 95% confidence interval of the proportion of trials that resulted in a correct response. Most dogs in the experimental group showed less of a decrement in the operational context compared with the training context. Interestingly one control dog, Sasha, maintained excellent performance in the operational context and two control dogs showed improvements across sessions (Dozer and Maxine). Nearly all experimental dogs, however, were able to maintain adequate performance in the operational context, with one clear exception (Pumpkin). Pumpkin showed a significant drop in performance in both the training and operational context during the test period, indicating global performance decrement (see FIG. 13).

Statistical analysis showed no significant increase in performance across the testing sessions (χ²=3.47, p=0.06). The interaction between group and context, however, was significant (χ²=327.26, p<0.001), indicating that the dogs' performance between the training and operational context differed between the experimental and control group. Tukey-adjusted post hoc tests showed that the experimental group in the operational context had greater accuracy relative to the control group (z=2.56, p=0.01; experimental: 90.68% vs. control: 60.05%; see Table 4). However, the experimental group had lower accuracy (z=2.03, p=0.002) in the training context than did the control group (experimental: 92.56% vs. control: 97.05%).

However, the results for one dog, Pumpkin, were unique across the population in that he showed a complete drop in performance in both the operational and training context. This highlights that the experimental training may not be ideal for all dogs. However, because his poor performance was a singular outlier and a different trend from all other dogs (a decrement in performance for both training and operational contexts), the inventors repeated the analysis without Pumpkin's data (see FIG. 14B). All results were statistically identical except that without Pumpkin's substantial decline across sessions in both contexts, the main effect of session was now statistically significant (χ²=40.28, p=<0.001). This indicates that accuracy overall increased with session number across all groups (except for Pumpkin). The remaining statistical analyses were therefore conducted excluding Pumpkin to avoid this dramatic decline to obscure trends among the other dogs. The data in Table 4 also exclude Pumpkin. Nonetheless, it is important to note that one of the nine experimental dogs showed complete extinction in both the training and operational context with the lowered prevalence of targets.

Latency. During the testing period, the inventors assessed whether the treatment reduced latency to approach the panel for experimental dogs. In the operational context, experimental dogs showed the first nose poke within approximately 6 s, whereas control dogs' latency was up to 17 s. In the training context, both groups showed a latency around 5 s, which was close to the latency observed for the experimental dogs in the operational context (see Table 4). The mixed-effect statistical model indicated there was a main effect of context (χ²=881.84, p<0.001), group (χ²=3.88, p=0.04), session (χ²=7.12, p<0.001), and the context-group interaction (χ²=341.86, p<0.001). Post hoc tests for the interaction indicate that experimental group had a lower latency to search in the operational context compared with the control group (z=3.46, p<0.001). The search latency of both groups in the training context was not statistically different.

Timeouts. During the testing period, the timeout rate was higher for the control group (35.33%) compared with the experimental group (7.12%) in the operational context (see Table 4). The main effect of context (χ²=189.39, p<0.001) and group (χ²=4.28, p=0.03) and the context by group interaction (χ²=84.94, p<0.001) on the probability that the dog made a timeout were statistically significant, but the main effect of session was not (χ²=0.39, p=0.53). A post hoc test for the interaction indicated that the experimental group had a lower probability of a time-out (i.e., incomplete search; z=2.35, p=0.02) in the operational context compared with the control group. There was no difference between experimental and control dogs in the training context.

Hits. During the testing period, the proportion of odor trials that correctly ended in a hit (i.e., a correct alert) was higher for the experimental group (98.12%) compared with the control group (71.11%) in the operational context (see Table 4). The probability of a correct hit was predicted by a significant context (operational and training context) by group (experimental and control) interaction (χ²=24.49, p<0.001) and by the main effect of context (χ²=129.77, p<0.001). The hit rate of the experimental dogs in the operational context was (z=4.07, p<0.001) statistically higher than the hit rate of control dogs. The proportion of hits between groups in the training context was not statistically different (z=0.68, p=0.49). The effect of session (χ²=3.20, p=0.07) and group (χ²=1.50, p=0.30) were both nonsignificant.

Correct rejections. During the testing period, the correct-rejection rate was higher for the experimental group (89.86%) compared with the control group (58.82%) in the operational context (see Table 4). The frequency of correct rejections was predicted by the group (experimental and control) and context (operational and training) interaction (χ²=57.68, p<0.001) and main effect of session (χ²=39.69, p<0.001), where correct rejections increased across sessions. The data showed that experimental dogs had correct rejections similar to those of the control group in the training context (z=0.34, p=0.64), but the experimental dogs showed higher correct rejection than control dogs in the operational context (z=2.89, p<0.01).

False alerts. During the testing period, the false-alert frequency was slightly higher for the control group (4.61%) than for the experimental group (2.12%) in the operational context (see Table 4). The frequency of false alerts was predicted by a group (experimental and control) and context (operational and training) interaction (χ²=49.78, p<0.001) and the main effect of session (χ²=80.96, p<0.001), where false alerts decreased across sessions. The data showed that experimental dogs had a higher false-alert rate in the training context relative to the control (z=2.85, p=0.004). No statistically significant difference in the false-alert rate was observed in the operational context between groups. The number of times a dog made a false alert during the entire testing period (out of 7,236 times the dog made a response, i.e., not including timeouts) in both the training and operational context was 59 times for mineral oil, 38 times for limonene, 36 times for gloves, 49 times for cotton ball, and 69 times for blank jar.

False all clears. During the test period in the operational context, the control group had a 0.0% false-all-clear rate, whereas the experimental group had 0.62% false all clears (one false all clear out of 160 searches with target odor) during the testing period, showing no relevant difference in this metric (see Table 4). These data represent that both control and experimental dogs rarely made an all-clear response when a target odor was in fact present and the dog poked their nose into all three ports.

These results from the laboratory model support that training dogs with systematically lower odor prevalence rates that more closely matched the simulated operational conditions led to moderately improved performance when challenged with the low prevalence rates in the operational condition. Unlike our prior attempts using noncontingent reinforcers or a Pavlovian conditioned stimulus to maintain search behavior (DeChant et al. in press), training dogs with systematically more intermittent schedules of odor prevalence did lead to improvements in performance that are noteworthy and important if translatable to deployed detection canines. This highlights the importance of dogs being conditioned to a high frequency of no-odor-present trials when there remain sufficient targets to maintain search.

High accuracy in the test condition after the low prevalence training was observed in eight of the nine experimental dogs. This suggests that the effect of the training is consistent and replicable among most of the dogs but that some dogs might have a lower tolerance to continuous training and testing under a low prevalence schedule. Experimental dogs had an increase in false alert rates during training context in the testing period, which suggests that some dogs may have started to show some response variability with lowered target frequencies. Such individual differences could be an interesting point for future investigation. If some dogs substantially tolerate more lean schedules of reinforcement, this could be a useful selection criterion for detection dogs that need to search with infrequent targets. Conversely, some dogs in the control group performed at high levels in the operational test. Given that these dogs participated in previous test sessions (e.g., Parts I and II), it is likely that the dogs may have had experience with intermittent odor frequency during prior tests, which was sufficient to prevent the performance decrement. Due to the randomization of when a target odor may appear, these dogs may have had sufficient training in prior studies with intermittent odor frequency to maintain performance. This is an unfortunate drawback to using the same participants across studies.

One interesting finding is that the false-all-clear rate was consistent throughout the study for all groups and conditions. This measure represents when the dog inserted their nose into the port that had the target odor and still called an all-clear response. This measure therefore largely reflects the odor occasioning of an alert, which remained largely unaffected by the odor prevalence rate. The performance decrement appears to be largely driven by reduction in search behavior (e.g., timeouts increasing).

There are several important limitations to the present study. First, to avoid potential confounding experimental effects, the dogs were not rerandomized into groups following prior experiences and they were not selected into group by performance (DeChant et al., in press). This leads to the potential that the effects observed may also relate to prior experiences. However, given that the previous manipulations had no effect on detection performance and that baseline performances were identical, this may have only been a minor limitation. Second, the present study used dogs that were purposely trained for this project, with only a few months of detection training. Operational dogs typically have years of prior training. Thus, it remains unclear whether the present results would translate to operational dogs.

To resolve some of the limitations of Experiment 1, Experiment 2 extended Experiment 1 with a larger cohort of operational dogs. Operational dogs were used because they regularly search contexts that have no or few targets present. The extension of Experiment 2 was to evaluate whether the effects of training with decreased frequency of target odors can lead to improvements in performance of certified operational dogs. However, several procedural modifications were necessary to make the study feasible for operational teams that had ongoing duties. The study timeline was condensed to 1 hr/day for 5 days, which necessitated procedural changes, which are noted in detail.

Effect of intermittent odor prevalence training on detection performance of operational detection canines.

Methods. Animals. Twenty-seven certified explosive detection dogs (12 Labrador Retrievers, six Belgian Malinois, two Dutch Shepherds, and seven German Shepherds) participated in this study. The dogs were from federal, county, city, and private organizations, and all had previously passed an independent certification exam. Two dogs (2a, 4b) were removed from the study due to illness not related to the study, one dog (8a) was removed due to failure to reach training criterion for the smokeless powder target within the allotted time, and one dog (13a) was removed due to the handler's personal emergency. Thus, 23 certified explosive detection dogs were used for analysis. The dogs' ages ranged from 3 to 8.5 years old, and all were handled by their regular handler who works the dog operationally. All procedures used in this experiment were reviewed and approved by TTU Institutional Animal Care and Use Committee (ACUC #19093-10).

Olfactometer training. The dogs were trained to search six individual Bluetooth automated olfactometers (see FIGS. 15A and 15B). Generally, FIGS. 15A and 15B show the olfactometer arrangement for Experiment 2. Six olfactometers were arranged in a semicircular pattern. Each olfactometer contained the target odor and five distractors. Handlers asked dogs to search the olfactometers, and when a dog made an alert (left image), the handler called the olfactometer indicated by the dog, which was then entered into the computer by the experimenter. The experimenter and handler were both blind to the location of the target odor. The computer would indicate correct responses with a “chirp” and incorrect responses with a buzzer. An all-clear response was marked with a simple end of trial tone. The number of olfactometers was increased from three to six to better match typically detection dog “line-up” procedures that the inventors anticipated the dogs would be more familiar with. The olfactometers were arranged in a semicircular pattern approximately 0.25 m apart. Each olfactometer could present any of six different odors to the odor port. These odors included double base smokeless powder (obtained from agency bunker at facility) and five distractors (vinyl gloves, cotton balls, toothpaste, duct tape, and blank jar). The distractors were selected based on availability and are common items used as distractors for detection training. Each olfactometer was battery operated and controlled via a central computer connected via Bluetooth. The mechanism of odor generation and the algorithm to determine target odor prevalence, location of the target, and distractors presented were identical to those in Experiment 1. An experimenter operated the computer during the study.

At the start of every trial, a tone cued the handler to start a search. If a dog alerted to an olfactometer, the handler would call out the number of the olfactometer. The experimenter would then enter this number into the computer, and the computer would respond with a correct or incorrect tone or neutral end-of-trial tone. The neutral end-of-trial tone was used when the dog made an all-clear response to mimic typical operational conditions for an all-clear response. Thus, the experimenter and handler were blind to the location of the target odor. If the handler did not call a response (i.e., either alert or all clear) within 45 s, it was recorded as a timeout, which was considered an incorrect response.

The performance measures collected were identical to those of Experiment 1 (i.e., Table 3), except for latency. Latency was not collected because this was largely handler driven, not dog behavior (i.e., handlers decided when, after the tone, they would send their dog to search). One important deviation from Experiment 1 is that canine responses were dependent on their handler's interpretation of the dog's behavior rather than the computer-scored infrared beams. This was required because the operational dogs all had different types of alerts (e.g., sitting, laying down, staring etc.); thus, the handler did serve an additional and important role in this experiment.

Study design. Due to the extended time required for the dogs to complete Experiment 1, direct replication was not feasible for working with operational detection canine teams. The study was therefore modified to be completed within five working days with 1-hr sessions each day. To achieve this, the inventors removed the within-subject comparison between contexts and minimized training time. Testing proceeded as follows: First, the dogs received a brief qualification session to confirm recognition and detection of the smokeless powder target and use of the six olfactometers followed by a pretraining test where the target odor frequency was reduced to 10%. This was completed on the first day of testing. Next, the dogs were randomly assigned to receive experimental or control training, which was restricted to 3 days. Last, the dogs received a posttraining test on the fifth day to reassess performance under infrequent target conditions.

Qualification. The initial qualification period consisted of one 10-trial session at 100% target odor prevalence. The qualification criterion was five consecutive correct trials or eight correct responses out of the 10 trials (e.g., accuracy ≥80%). The training criterion was reduced to 80% (compared with Experiment 1) due to the time constraint of 5 days for testing. The purpose of this qualification was simply to familiarize the dogs and handlers with the olfactometer and ensure appropriate odor detection for the target odor and that handlers understood how the olfactometers operated. Only the last five trials of the qualification period were retained for data analysis. The dogs progressed to the pretraining testing period after completion of the qualification period. Twenty-six of the 27 dogs completed the qualification period within 10 trials or less, indicating rapid transfer to the olfactometer boxes. The dog that did not meet qualification was not included. Throughout the study, three additional dogs (2a, 4b, 8a) discontinued participation due to unrelated conflicts from the study during the training period and were not included in the analyses. Thus, only 23 dogs are included in the analyses, figures, and tables.

Pretraining testing. Each dog received one 20-trial session for the pretraining testing period in which the frequency of a target odor appearing in one of the six boxes on a trial was lowered to 10% (e.g., 18 trials had distractor odors only and only on two trials did a box contain a target). Following the pretraining test, the dogs progressed to the training period and were randomly assigned into two training groups for the experimental design.

Training. Eleven dogs were randomly assigned to the control group in which for the entire training period the target odor prevalence remained at 90%. The other 12 dogs were grouped into the experimental (b) group, where the target odor prevalence rate started at 90% and was systematically reduced by 10% after every session achieving an accuracy ≥80%. If a dog met the accuracy criterion in all sessions, the dog would reach a target prevalence rate of 20% prior to posttraining testing. If the dog did not reach accuracy of 80% or greater, it had an additional session at that odor prevalence until it met or exceeded the 80% accuracy criterion. The objective was to train the experimental group with a lower odor prevalence rate, whereas the control group received matched training sessions at a consistent target odor prevalence.

The training period was a total of 3 days with 2-3 sessions per day. The time between each session was at least 5 min to allow the dog to get water and rest for a longer period if needed. The timeline for this study was limited as such based on canine availability from operational duties and thus needed to be fit within these parameters. Ten experimental dogs (1b, 3b, 5b, 6b, 7b, 9b, 10b, 11b, 12b, and 13b) completed the training to 20% target prevalence, and the remaining two dogs (2b and 14b) reached 30% target odor prevalence during the training period. Dog 2b reached accuracy of 80% or greater at 30% target prevalence. Dog 14b did not reach 80% or greater accuracy at 30% target odor prevalence, and were limited in time to continue training and therefore progressed to the posttraining test.

Posttraining testing. All dogs received a total of three 20-trial sessions for the posttraining testing period. The first session was at 10% target odor prevalence, identical to the pretraining test. The second session was at 5% target odor prevalence, and the final session was at 0% target odor prevalence. The target prevalence was lowered in the last two sessions to provide an additional challenge for operational dogs that have been completing search tasks for an extensive period.

Video coding. An ethogram based on Part I (see Table 1 in Aviles-Rosa et al., in press) was modified to video code canine search behavior during the pretraining test and posttraining test sessions. In total, there were 92 videos, where 30% of the videos were double coded. The interobserver agreement is shown in Table 5. To permit analysis of the scored behaviors, a retention criterion was implemented such that a behavior needed to be observed at least 10 times (or 10 times for each level of a factor) out of the 1,840 coded trials (>0.5% frequency). In addition, the interclass correlation (ICC) for interobserver agreement needed to be >0.4, reflecting adequate agreement. Percentage of agreement was used to assess interobserver agreement for tail position and search pattern because of the infrequency of some behaviors (e.g., tail tucked and incomplete search, no search, and drive-by search). The video-coded behaviors were combined with accuracy derived from the olfactometers to identify whether any specific video-coded behaviors were associated with performance.

TABLE 5

| Behavior | | |
|---|---|---|
| description | Behavior coded | Agreement |
| Search | 0. No search (dog did not | Values other than “3” |
| behavior | search any olfactometers) | too infrequent |
| | 1. Drive-by search (dog | |
| | hovered but did not fully | |
| | insert nose) | |
| | 2. Incomplete search (dog | |
| | missed an olfactometer but | |
| | trial completed) | |
| | 3. Thorough search (dog | |
| | searched all 6 olfactometers | |
| | and/or made an alert) | |
| General | 1. Paw at olfactometer | 1. Values too infrequent |
| behaviors | 2. Vocalization during search | 2. Values too infrequent |
| | 3. On leash or off leash | 3. ICC = 0.97 |
| | 4. Handler asked dog to search | 4. ICC = 0.53 |
| | one olfactometer again | |
| Tail | 1. Wagging | % Agreement 96.70 |
| position | 2. Relaxed | |
| | 3. Tucked | |
| | 4. Aroused/Raised | |
| Search | 1. Linear | % Agreement 91.03 |
| pattern | 2. Random | |
| | 3. Skipped an olfactometer | |

Statistical analysis. The analyses evaluated the effect of training assignment (control or experimental) on posttraining testing performance. To assess the effect of the experimental progressively lowered odor prevalence training on accuracy, a logistic generalized linear mixed-effect model was fit in which an interaction of group (experimental vs. control) and odor prevalence rate (10, 5, and 0%) was assessed. The dependent variable was the trial outcome (1 for correct and 0 for incorrect). This was also predicted by a random intercept for each dog. An otherwise identical fixed and mixed-effect model was fit to predict false alerts, timeouts, false all clears, and correct rejections. The Imer package (Kuznetsova et al., 2017) in R (R version 3.5.1, www.r.project.org; R Core Team, 2018) was used to fit models. For the 30% double-coded video behaviors, the ICC package in R was used for interobserver agreement. To assess whether any video coded behaviors predicted overall accuracy, a logistic generalized linear mixed-effect model in which accuracy (correct or incorrect response) was predicted by the behavioral measures that meet the retention criteria with a random effect of dog.

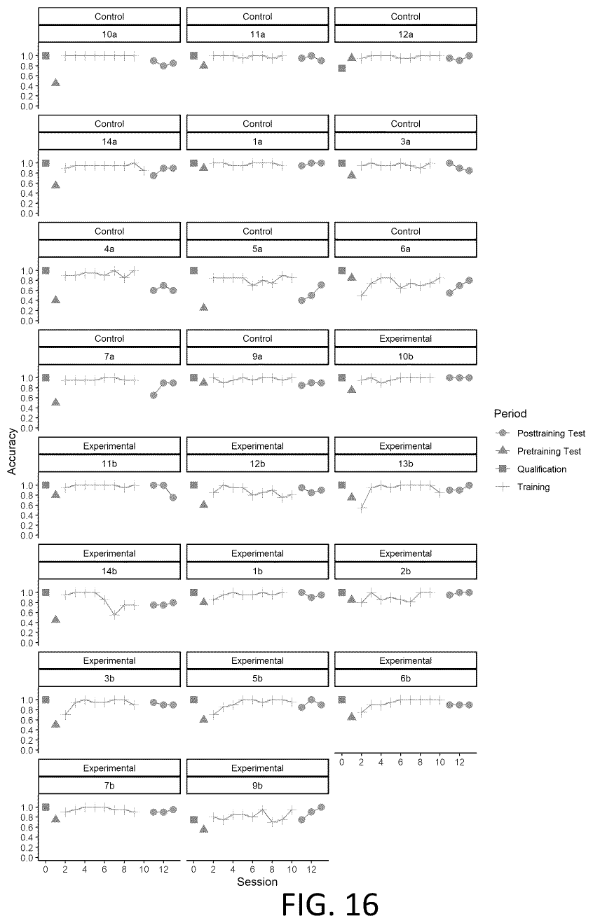

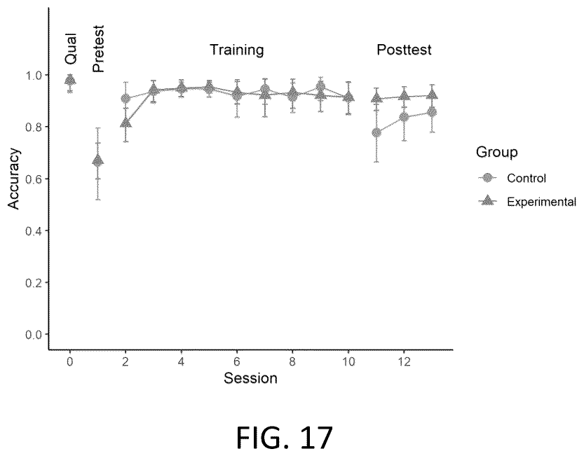

FIG. 16 shows individual dog performance by group and period. Specifically, FIG. 16 shows individual dog accuracy (which includes hits and correct rejections) data for Experiment 2. The point for the qualification period summarizes the last five trials. Each point for the pretraining test, training, and posttraining test periods summarizes 20 trials for each session. FIG. 17 shows dog performance by group (experimental and control). Generally, FIG. 17 shows overall accuracy: the average accuracy for both experimental and control group during the qualification period (Qual), pretraining test, training, and the posttraining test. Error bars represent 95% confidence interval of the percentage of odor trials that resulted in a correct response. Dogs in the experimental group had greater performance during the posttraining test than did control dogs, but otherwise both groups had identical performance in the qualification, pretraining test, and training periods. Table 6 shows the mean and standard deviation of accuracy, false alerts, timeouts, hits, and correct rejections, by group and period.

TABLE 6

| | Pretraining test | | Training | | Posttraining test | |
|---|---|---|---|---|---|---|
| | Control¹ | Experimental¹ | Control¹ | Experimental¹ | Control¹ | Experimental¹ |
| Accuracy | 66.36 ± | 67.08 ± | 90.11 ± | 92.04 ± | 82.36 ± | 91.55 ± |
| | 24.09 | 13.04 | 8.78 | 4.73 | 14.39 | 5.78 |
| False alert | 30.90 ± | 26.66 ± | 5.96 ± | 6.00 ± | 17.48 ± | 8.02 ± |
| | 23.00 | 13.20 | 6.008 | 4.91 | 14.39 | 5.84 |
| Timeout | 2.72 ± | 6.25 ± | 0.21 ± | 0.28 ± | 0.00 ± | 0.13 ± |
| | 4.67 | 14.16 | 0.37 | 0.34 | 0.00 | 0.48 |
| False-all- | 0.00 | 0.00 | 4.99 ± | 3.87 ± | 3.03 ± | 5.55 ± |
| clear rate | | | 5.72 | 2.70 | 10.05 | 12.97 |
| Correct | 63.63 ± | 64.35 ± | 84.34 ± | 90.78 ± | 81.76 ± | 91.66 ± |
| rejection | 25.01 | 13.07 | 13.90 | 6.96 | 15.35 | 5.73 |

Accuracy. FIG. 4 shows the accuracy by individual dog. Although some control dogs performed similarly to the experimental dogs, overall, the experimental group had greater accuracy (91.55%) in the posttraining test period compared with the control group (82.36%; see FIG. 5 and Table 4). The interaction between group and odor prevalence was not statistically significant (χ²=1.71, df=2, p=0.55), indicating that the group difference was consistent for each low odor prevalence tested (10, 5, and 0%). The main effect of group on dogs' accuracy was significant (χ²=4.08, df=1, p=0.04). Thus, dogs in the experimental group that received the experimental training, overall, showed higher detection accuracy during all sessions of the posttest in comparison with the control group. The main effect of odor prevalence rate was not statistically significant (χ²=4.89, df=2, p=0.086).

False alerts. During the posttraining test, the control group had more false alerts (17.48%) compared with the experimental group (8.02%; see Table 5). The interaction between group and odor prevalence was not significant (χ²=1.16, df=2, p=0.55) for false-alert rate. The main effect of group on dogs' false-alert rate was statistically significant (χ²=4.55, df=1, p=0.032), and the main effect of odor prevalence rate was not significant (χ²=4.29, df=1, p=0.11). Thus, dogs in the experimental group showed fewer false alerts than did those in the control group.

Timeouts. During the posttraining test, the experimental group had a slightly higher timeout rate (0.13%) compared with the control group (0%), which is attributed to one dog stopping in the middle of searching to get water and running out of time (see Table 5). The interaction between group and odor prevalence was not significant (χ²=0.0003, p=0.98) for the timeout rate during posttraining test. The main effect of group on dogs' timeout rate was not statistically significant (χ²=0.0038, p=0.095), and the main effect of odor prevalence rate was not significant (χ²=0.000, p=0.099). Therefore, the timeout rate remained similar for the two groups during posttraining test.

False all clears. During the posttraining test, the experimental group had slightly higher false-all-clear rates (5.55%) compared with the control group (3.03%; see Table 5). The interaction between group and odor prevalence was not significant (χ²=0.0024, df=1, p=0.96) for the false-all-clear rate.

The main effect of group on the dogs' false-all-clear rate was not statistically significant (χ²=0.0039, df=1, p=0.949), and the main effect of odor prevalence rate was not significant (χ²=254, df=1, p=0.613). Thus, the false-all-clear rate remained similar for the two groups during the posttraining test.

Correct rejections. During the posttraining test, the experimental group had higher correct-rejection rate (91.66%) compared with the control group (81.76%; see Table 5). The interaction between group and odor prevalence was not significant (χ²=1.50, df=2, p=0.47) for correct-rejection rate during the posttraining test. The main effect of group on the dogs' correct rejection rate was statistically significant (χ²=4.02, df=1, p=0.044), and the main effect of odor prevalence rate was significant (χ²=6.18, df=2, p=0.045) for correct-rejection rate. The experimental group had a higher correct-rejection rate compared with the control group.

Behavior video coding. Table 6 shows the behaviors excluded due to infrequency. A thorough search was scored for nearly all trials. This is an interesting deviation from our prior work that showed substantial decreases in the search score. Interestingly, however, an unaccounted variable in this measure is the frequency with which handers re-sent a dog to reinvestigate one olfactometer. This was scored 832 times over 174 trials, indicating that perhaps handlers are noticing reduced search and are re-sending dogs to missed olfactometers, which is causing all trials to end with a complete search. Overall, the number of times a handler asked a dog to reinvestigate the olfactometers was 434 times for the control group and 398 times for the experimental group.

The retained behaviors were therefore tail position, whether the dog was worked on or off leash, and whether the handler asked the dog to re-search a box. None of the retained behaviors statistically predicted trial accuracy (tail position: p=0.58, on leash: p=0.59, handler asked dog to search again: p=0.41).

Overall, the results of Experiment 2 help confirm the results of Experiment 1. The magnitude of the effects was a little lower, which is not unexpected given that the operational dogs have substantially longer histories working in varied environments and training practices. One limitation for Experiment 2 was the shortened time available to use the operational dogs. The dogs were needed for their regular operational work (searching venues). It was, therefore, not feasible to directly replicate Experiment 1. Another limitation for Experiment 2 was our decision to not include all-clear signals during the initial qualification period. The inventors did not include this due to the time constraint, so the qualification was designed to be as short as possible to simply demonstrate that the dog could detect SP and use the olfactometers to search without issue. Nonetheless, in Experiment 2, the confirmation that the proposed training for increased intermittency of odor frequency led to improvements of already-operational dogs highlights the potential importance of this training consideration for detection canines.

The effects of training dogs under progressively lower prevalence rates on detection accuracy were evaluated in this study under laboratory and applied conditions. The low-prevalence training improved the dogs' performance under both laboratory conditions and applied conditions with operational detection canines. Of all the mitigation strategies the inventors evaluated (DeChant et al., in press, Part II), training dogs under a low-prevalence schedule seems to be the most effective method to maintain search performance with infrequent targets.

The inventors found that a simulated search behavior under a lean schedule of reinforcement was more resistant to extinction compared with the same behavior trained under a rich schedule of reinforcement. The training schedule used for the experimental groups placed search behaviors under an intermittent schedule of reinforcement, making it more resistant to lean schedules of odor appearance (e.g., partial reinforcement effect). Because within the experimental framework, poor performance (e.g., increase in false-alert and timeout rates) is driven by extinction of search behavior and not the odor-alert-reinforcer contingency, making search more resistant to extinction has important consequential effects on detection performance.

The average performance of the control group also improved in both Experiments 1 and 2. This suggests that in addition to systematically lowering the target odor schedule, the dogs may have adjusted to the intermittent reinforcement schedule over time. However, further research is needed to observe the performance for the control dogs under a similar scenario with an increase in sessions, as their performance may reach similar accuracy compared with the experimental dogs with more testing sessions.

Interestingly, one noticeable difference between Experiment 1 and Experiment 2 was that operational dogs' response to infrequent targets was to engage in false alerts. This is expected extinction-induced response variability but differs from the increased number of timeouts the inventors observed in Experiment 1. In Experiment 1, the inventors observed only a minor increase in false alerts within the laboratory conditions, but the inventors observed more timeouts and failure to search as the response to extinction of search behavior. These differences likely reflect that (1) laboratory dogs were previously naïve to detection work, with only 1 month of training, whereas operational dogs had years of training and experience and (2) operational dogs were largely tested on leash and walked by the handler. Laboratory dogs were worked off leash and were free to engage in other behaviors, but leashed dogs may be more likely to engage in search when directed on leash by the handler. This is further indicated by the fact that handlers re-sent their dogs to re-search or better search boxes on 174 trials. Perhaps without handler intervention, these would have been the timeouts observed in the laboratory conditions with minimal experimenter intervention. A future study observing the influence of handler intervention and detailed search would be interesting to conduct with operational dogs.

An additional important consideration between the laboratory and operational period is that substantially more data could be collected in the laboratory period. For Experiment 1, dogs were tested in low-prevalence conditions over 5-day periods, which is five times longer than what was done in Experiment 2. The shortened timeline for Experiment 2 was necessary because this would have required operational dogs to not be available to agencies for well over 2 weeks, which simply would not fit with day-to-day operational needs.

Interestingly, due to some of these differences, the behavioral data of the dogs became less informative in predicting accuracy than was observed in the laboratory condition in Part I (see Aviles-Rosa et al., in press). This seems to be driven primarily by the fact that handlers were successful in intervening when dog search was showing signs of decline and re-sent dogs to the boxes repeatedly. This made nearly all trials have a final search score of “thorough search.” Interestingly, however, for the five trials in which the search score was not rated as thorough, overall accuracy was 40% (two misses, one false alert, and two correct all clears). Although not subject to statistical analysis, it does again highlight the importance of visually inspecting for thorough search behavior, reflecting the highest miss rate in the study that was observed when the search score was not thorough.

It appears there was not a clear predictor of an increased probability of a false alert. It is important to note, however, that the behavioral-coding agreement was on the borderline of acceptable. This was largely driven by the infrequency of the behaviors in the coded videos, making one or two disagreements have substantial effects on agreement scores. Nonetheless, agreement when a behavior did not occur was very high, indicating that the borderline agreement scores likely did not substantially affect the outcomes of this analysis.

Interestingly, across both experiments, the relation between the probability of an alert given the dog sampled the target odor box did not change. If the dogs encountered the target odor (sampled the box with the target), detection was very high (e.g., probability of a miss was low: false all clear). This suggests that although the first link of the behavior chain may have been undergoing extinction (search behavior), the second link was not interrupted (alert behavior). Rather, the disruption of the first link (search behavior) led to disruption in accessing the odor for alerting/detection, but the second link showed minimal disruption.

These results highlight that the intermittency of odor prevalence is a very important and relevant variable that requires attention for detection dogs. Systematically training dogs to a schedule of odor prevalence that is similar to operational conditions is important. However, this manipulation can likely only be used in conjunction with other efforts to reduce extinction of search behavior. Regardless of the intermittency training, extinction would occur in situations in which targets (e.g., explosives) are never encountered. Thus, the combination of intermittency training for odor prevalence as well as use of innocuous odors (i.e., Porritt et al., 2015) may be highly compatible approaches that will maintain search behavior for few target odors that can be feasible to maintain in operational conditions.

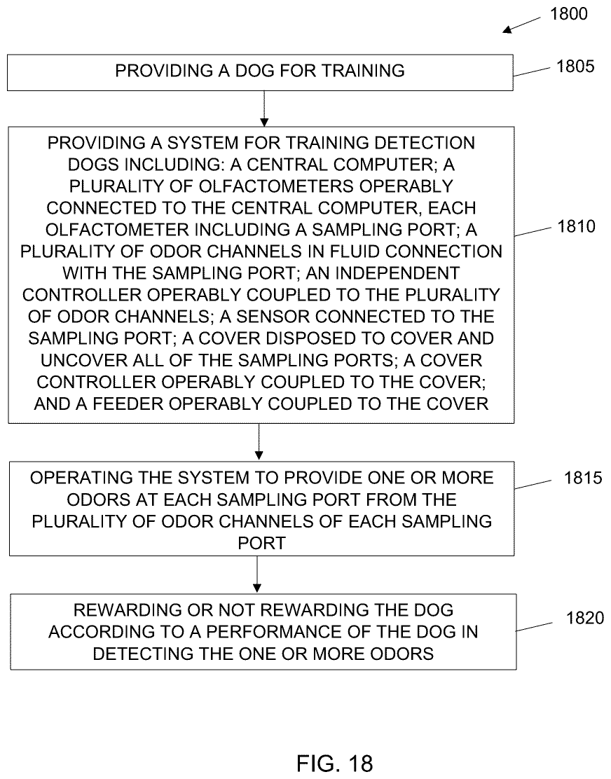

FIG. 18 shows a method embodiment of the present invention. The method 1800 of training detection dogs includes: block 1805, which includes providing a dog for training and block 1810, which includes providing a system for training detection dogs including a central computer; a plurality of olfactometers operably connected to the central computer, each olfactometer including a sampling port; a plurality of odor channels in fluid communication with the sampling port; an independent controller operably coupled to the plurality of odor channels;

and a sensor connected to the sampling port; a cover disposed to cover and uncover all of the sampling ports; a cover controller operably coupled to the cover; and a feeder operably coupled to the cover controller. Block 1815 includes operating the system to provide one or more odors at each sampling port from the plurality of odor channels of each sampling port; allowing the dog to sniff each sampling port. Block 1820 includes rewarding or not rewarding the dog according to a performance of the dog in detecting the one or more odors.

In conclusion, the present experiments showed that under infrequent target odor conditions, search behavior was disrupted for dogs in the control group, leading to poorer performance. Training experimental dogs through an incremental training program with increasingly more infrequent target odors led to improvement in overall performance and accuracy in Experiments 1 and 2. This highlights that the partial reinforcement effect can be used to increase resistance to extinction of search behaviors for working detection dogs.

Further experimentation included training odor-naïve dogs to detect 1-bromo-octane with an embodiment of the present invention. Four mixed-breed dogs (n=4) were selected from the local animal shelter based on their food motivation and trainability (see Table 7 for participant demographics).

TABLE 7

| Dog | Breed | Age | Spay/Neuter status |
|---|---|---|---|
| Foxy | Pitbull mix | 1.5 y | F/spayed |
| Oakwood | Shepherd mix | 1.5 y | M/neutered |
| Stan | Border collie | 1.5 y | M/neutered |
| Wolfgang | Mastiff mix | 1 y | M/neutered |

Throughout the duration of this experimentation, the dogs were housed at the Canine Olfaction Education and Research facility at Texas Tech University. The dogs received daily enrichment (walks, play groups, and training). Dog care and use was approved by Texas Tech University IACUC #2024-1468.

Odor. Training started with a biologically relevant target (hot dog or Biljacs®). After reaching the first training criterion, described below, dogs were trained to detect a 10-2, 10-3, and 10-4 v/v solution of 1-bromo-octane (Thermo Scientific®, CAS #111-83-1) diluted in mineral oil (Fisher Scientific®, CAS #8042-47-5). The inventors chose 1-bromo-octane because it is a commonly used target in detection dog training (Maughan et al., Calibrating canines-a universal detector calibrant for detection dogs, Front. Allergy, 11 Mar. 2024, Volume 5 doi.org/10.3389/falgy.2024.1366596).

The inventors also trained dogs to not respond to non-target/distractor odors including: 10⁻³ v/v solutions of ethyl tiglate (CAS #5837-78-5), 10⁻³ v/v and 10⁻⁴ v/v solutions of d-Limonene (CAS #5989-27-5), 10⁻³ v/v solution of pistachio flavoring oil (LorAnn oils), and 10⁻⁴ v/v solution isobutyl propionate (CAS #540-42-1). These non-target odors were selected based of their availability.

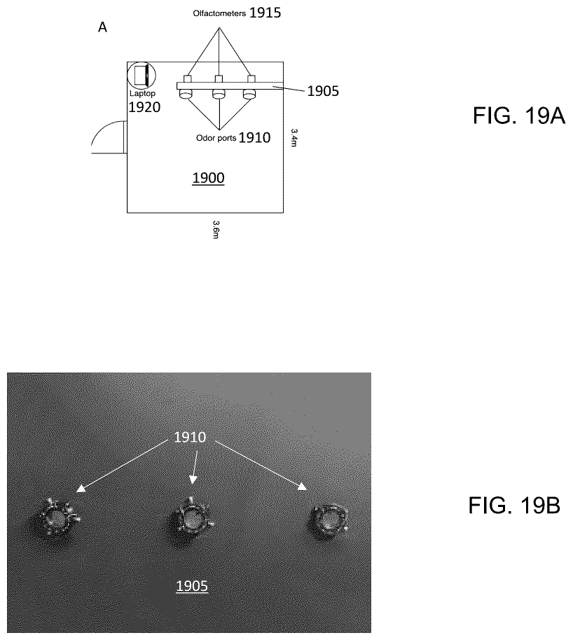

Experimental set-up: training room. Initial training was conducted in a 3.4 m×3.6 m room. This room was equipped with a 1.2 m-high scent wall. The wall was constructed from painted plywood plank. Four holes (0.6 m from ground) were drilled for the odor ports. See FIG. 19A for a room schematic and FIG. 19B for a picture of the scent wall. FIG. 19A shows the training room 1900, a scent wall 1905 on which are mounted odor ports 1910 and olfactometers 1915, and a laptop computer 1920 for control of the experimental setup. FIG. 19B shows the scent wall 1905 and three odor ports 1910.

Olfactometer. Odor valve activation and deactivation was controlled by an automated computer program. For each trial, the activated valve was randomly selected by the computer program. When an odor valve was activated, air from the odor line (0.8 L/min), generated from a small air pump inside the olfactometer's casing, entered the activated odor vial through a small polytetrafluoroethylene (PTFE) tube. The headspace of the activated vial was carried through another small PTFE tube to a PTFE manifold where it was mixed with continuous clean air stream (0.8 L/min). The diluted odor (50% air dilution) was transferred through a PTFE tube to a glass jar odor port. Table 8 presents a list of olfactometer settings.

TABLE 8

| Setting | Description |
|---|---|
| Trial Number | Number of trials per session |
| Alert Time | Number of seconds dog needs to hold a nose |
| | poke to be counted as a response |
| Add Random to alert | Randomly varies alert duration by the |
| | specified time in seconds |
| Trial Time | Number of seconds the dog has to respond |
| | before the trial times out |
| Session | Session number |
| Blind | Chooses whether the handler is aware of the |
| | location of the target odor |
| Wait for Correct | Selects whether the program will wait for a |
| | correct response before moving onto the next |
| | trial |
| Target Frequency | Proportion of trials in which the target odor is |
| | presented |
| Reinforce Targets | Proportion of trials in which correct alerts are |
| | reinforced |
| Reinforce Blanks | Proportion of trials in which a non-target |
| | (blank) indication is reinforced |
| Target presentation | Used to randomize target odors across trials |
| | (randomized) or present a target odor |
| | consecutively according to a denoted weight |
| | before moving onto the next target odor |
| | (blocked) |
| Score by IR | Indicates whether the response will be scored |
| | by breaking the IR beam for the specified |
| | alert time or if the response will be selected |
| | manually by handler |
| Tones | Indicates whether correct/incorrect tones will |
| | sound after a response |
| IR Lights | Option to turn on an LED ring to indicate |
| | response duration to handler |
| Probe Trials | Number of trials in which targets indicated as |
| | a probe are neither reinforced or marked as |
| | incorrect |
| Collect Video | Indicates whether to record a video of each |
| | trial |
| Data Tag | Adds a note of the type of session for later |
| | analysis by the user |
| Mixture Components | Indicates the amount of components in a |
| | presented mixture out of the odors designated |
| | as mixture |
| Notes | Write any other information that pertains to |
| | the session in the data sheet |

Infrared/Light emitting diode ring. A light emitting diode (LED) ring equipped with an infrared (IR) beam in the ring recorded dog alerts to odor. At the beginning of a trial, a light at the top of the ring turned white indicating a visual cue to the handler that the trial has started. When a dog sampled a port, the light at the top of the ring turned off to indicate that the dog had searched that port (i.e. broke the IR beam). The IR beams were also used to record the duration of a nose hold (e.g. an alert). When a dog performed a nose hold, the lights of the ring turned on in sequence for a predetermined alert time. If the dog performed a correct alert, all the ring lights turned blue at the end of the light sequence. If the dog performed a false alert, the ring lights turned red at the end of the light sequence.

Training plan. Table 9 presents the training plan.

TABLE 9

| | | | Alert | | Wait for | Handler | Criterion to Move to |
|---|---|---|---|---|---|---|---|
| Training Phase | | Target Odor | Duration | | Correct? | Blind? | Next Phase |
| 1. | Loading the | N/A | N/A | | N/A | N/A | Dogs show immediate |
| | marker | | | | | | response following the |
| | | | | | | | marker |
| 2. | Prompting | Food | N/A | | N/A | N/A | Dog searched each port |
| | nose | | | | | | to access treat |
| | insertions | | | | | | |
| | and search | | | | | | |
| 3. | Search | Food | 0.5-2 | s | Y | N | 2 consecutive sessions of |
| | training with | | | | | | 10 trials each with 80%+ |
| | biologically | | | | | | accuracy with wait for |
| | relevant | | | | | | correct off and handler |
| | target odor | | | | | | blind |
| 4. | Search | 1-bromooctane | 0.5-3 | s | Y | N at | 2 consecutive sessions of |
| | training with | | | | | first; | 10 trials each with 80%+ |
| | 1-bromooctane | | | | | Y when | accuracy with wait for |
| | | | | | | 1.5 s | correct off and handler |
| | | | | | | hold | blind |
| | | | | | | starts | |
| 5. | Stimulus | 1-bromooctane | 3 | s | Dog | Y | 2 consecutive sessions of |
| | control | | | | dependent | | 10 trials each with 80%+ |
| | training | | | | | | accuracy |
| 6. | Non-target | N/A | N/A | | Y | Y | 2 consecutive sessions of |
| | training | | | | | | 10 trials each with 80%+ |
| | | | | | | | accuracy |
| 7. | Odor | 1-bromooctane | 0.5-3 | s | Dog | Y | 2 consecutive sessions of |

| | | | |
|---|---|---|---|
| variation | (various | dependent | 10 trials each with 80%+ |
| training | concentrations) | | accuracy |

Loading the marker. In step 1, the inventors acclimated the dogs to the training room and conditioned a marker. In the training room (see FIG. 1), the inventors paired a stimulus (click or “yes”) with primary reinforcer (hot dog or BILJACS®). For each conditioning trial, the “click” or “yes” was followed by immediate delivery of treats tossed on the ground. There was a variable 15-30 s inter-trial-interval. Trials continued until dogs showed an immediate response toward the handler or location where food was delivered following the conditioned stimulus. This required 2-10 min.

Prompting nose insertions and search. During step 2, all olfactometers were off, but the pumps were activated to facilitate habituation to airflow or pump noises, but the olfactometers did not deliver odor.

In step 2.1 the inventors prompted search behavior by placing a treat or reinforcer into one of the odor ports (FIG. 1) while the dog watched and allowing the dog to obtain the reinforcer. This step was completed once a dog readily went to the baited port (typically within 5 trials).

Step 2.2 changed the baiting to invisible placement (dog visually obstructed during treat placement) to prompt searching for the primary reinforcer. The dog was released after the baiting to check each odor port for their primary reinforcer. This step continued until the dog searched each port and accessed the primary reinforcer from the baited port. This was typically accomplished within 10 trials.

Search training with biologically relevant target odor. From step 3 onward, the olfactometers are used to deliver all odors and record behavior.

Step 3.1. 0-0.5 s indication training. This step trained the desired nose insertion response to the odor port. At the start of each trial the computer would display the olfactometer that presented the target odor (food) (i.e. the handler was unblinded). Target presentation was pseudo-randomized between the three olfactometers so that within every set of ten trials the target odor appeared in two olfactometers three times and one olfactometer four times. The other two olfactometers presented air from empty vials. The dog is sent to search with a “search” cue.

The first two to five trials of this training step looked identical to acclimatization training, in that the handler would place food into the odor port which was blowing the odor of the target. Dogs were initially marked for just inserting their nose into the odor port containing the target odor. After these initial trials, the handler stopped putting food in the odor port of the target olfactometer. The dog was still marked for inserting their nose in the olfactometer. Over time the handler began delaying the marker so that the dog was required to hold their nose in the odor port for longer durations (shaping the nose hold response). If the dog removed their nose from the odor port during this time the handler would wait until the dog re-inserted their nose and held for the desired duration.

The nose hold criterion was increased slowly to avoid search behavior extinction. If a dog started displaying signs of behavioral extinction (e.g. avoiding the scent wall, lying down, barking) the user would reduce nose hold criterion, or go back to placing food in the target odor port for one trial. Once a dog successfully completed ten trials with a 0.5 s nose hold duration without handler intervention (no baited odor ports) the dog moved to the next stage.

Step 3.2. Is indication training. In this stage of training, the olfactometer's IR technology was used. An alert duration set for these trials to 1 s, meaning the dog had to hold their nose in the odor port and break the IR beam for Is to trigger a correct trial tone (another conditioned stimulus, like the marker). The handler provided the primary reinforcer (food) after this tone.

During this phase, the handler was still unblinded to the location of the target odor. If at any point during this training a dog started to show signs of extinction (e.g., not performing the search task, avoiding the scent wall, laying down), the handler would mark nose holds of less than 1 s (decrease the training criteria for a few trials).

To move onto the next training phase dogs were required to hold their nose in the target olfactometer for a Is duration without handler intervention (marking shorter approximations of nose hold duration) for ten trials. During this training phase the dog was not penalized for holding a 1 s nose hold in a non-target olfactometer. The program “waited for the correct” response.

Step 3.3. 1.5 s indication training. This training phase was identical to the prior phase except that the nose hold duration was increased to 1.5 s and the handler was blinded to the location of the target odor. Handlers were blinded to the location of the target odor to prevent unintentional cuing. Due to handler blindness, dogs could no longer be reinforced for successive approximation of the nose-hold behavior. If dogs started showing signs of extinction of the search behavior, they were moved back to step 3.2 (reducing training criteria).

Step 3.4.1. 2 s indication training. In this final training phase with this food target odor the alert duration was increased to two seconds, but all other settings remained the same. If a dog correctly identified and indicated on the target odor olfactometer without handler intervention at 80% accuracy across two sets of ten trials they would move on to the next phase.

Step 3.4.2. 2 s indication training with no reward marker. Dogs that failed to meet the 3.4 criterion continued to work with this odor at this alert duration, but the dogs were penalized for indicating on a non-target olfactometer port (false alert) or leaving the search area after checking each odor port without indicating on any (false negative). A no-reward sound would play, terminating a trial and ending without the delivery of a reward. In other words, the olfactometer program no longer waited for dogs to correctly identify their target (wait for correct off). Once dogs achieved 80% accuracy across two sessions of ten trials they moved to the next phase.

Step 4. Search training with 1-bromo-octane.

Step 4.1. 0-0.5 indication training. This training phase mirrored that of the 0-0.5 s indication training phase for the food target odor, but in this phase 1-bromo-octane was used as the target odor. Dogs moved on from this training phase after ten trials of handler-marked trials.

Step 4.2. Is indication training. This phase was similar to the 1 s indication phase for the food target odor; however, if a dog showed signs of extinction on this phase, the inventors began inter-mixing target odor trials. To maintain search behavior, the user would set the olfactometer program so that three out of every four trials had the food odor as the target, and one had the 1-bromo-octane. The inventors decreased the prevalence of the food target trials until the dog was searching for 1-bromo-octane only and holding a Is nose hold in the target port without handler intervention for ten trials. The handler was unblinded to the location of the target odor during this phase.

Step 4.3. 1.5-3 s indication training. The inventors increased the alert duration by 0.5 s after each ten-trial session, if the dog worked without handler intervention and did not show signs of extinction. The handler was blind to the location of the target throughout these training phases.

Once dogs reached a 3 s nose-hold duration, the inventors required dogs to correctly indicate to 1-bromo-octane in 80% of trials across two sets of ten trials to move to the next phase. If a dog did not meet this requirement, they continued working but the “wait for correct” setting was turned off leading to the termination of the trial with no-reward for false alerts and misses.

Step 5. Stimulus control training. Thus far the dogs only had to discriminate their target odor (food, or 1-bromo-octane) from clean air. In this next phase the inventors introduced non-target odors. The inventors used four distractors (two per session) of varying salience. During this introduction, wait for correct was set on, ignoring any false indications dogs gave to distractors during these trials.

If dogs achieved 80% accuracy across two sessions of ten trials for each set of distractors, they moved to the next training phase. If not, the inventors turned wait for correct setting off, which terminated the trial without reward for false alerts and misses.

Step 6. Non-target training. The inventors next trained dogs to search the scent wall when no target was present. Initially the inventors cued dogs to search and after they inserted their nose into each odor port, the inventors called the dogs back to us. Slowly the inventors faded out the recall cue. Dogs were trained to search with an 80% target odor prevalence per session, whereby 8 out of 10 trials contained a target odor in one of the olfactometers and 2 of the 10 trials only had distractors in all olfactometers.

Once dogs returned to the handler without a cue and after searching all three ports, handlers were again blinded to the position of the target odor (and its presence/absence). If dogs achieved 80% accuracy across two sets of ten trials at this phase they moved to the next phase. If dogs did not achieve this criterion, again, the inventors turned off the “wait for correct” programming on the olfactometer program which terminated trials with incorrect responses without reward.

Step 7. Training on various odor variation. Finally, the inventors trained dogs to respond to varying concentration of the target odor.

As embodied and broadly described herein, an aspect of the present disclosure relates to a system for training detection dogs comprising, consisting essentially of, or consisting of: a central computer; a plurality of olfactometers operably connected to the central computer, each olfactometer comprising: one or more sampling ports; a plurality of odor channels in fluid communication with the one or more sampling ports; an independent controller operably coupled to the plurality of odor channels; and a sensor connected to the one or more sampling ports; one or more covers disposed to cover and uncover one or more of the one or more sampling ports; a cover controller operably coupled to the cover; and a feeder operably coupled to the cover controller. In one aspect, independent controller of the one or more sampling ports comprises a program to present an odor from one of the plurality of odor channels to the one or more sampling ports. In another aspect, the one or more sensor of the one or more sampling ports is disposed to measure a nose hold of a dog at the one or more sampling ports. In another aspect, the cover controller comprises a program to operate the one or more covers. In another aspect, the cover controller comprises a program to operate the feeder when one or more specified conditions are met. In another aspect, the one or more sensors are operably configured to determine when one or more specified conditions are met. In another aspect, the central computer comprises a program to operate the system to train detection dogs to indicate detection of a specified odor from the plurality of odor channels. In another aspect, each of the plurality of olfactometers is remotely controllable. In another aspect, each of the plurality of olfactometers is remotely controllable by long-range radio. In another aspect, each of the plurality of olfactometers is portable.

As embodied and broadly described herein, an aspect of the present disclosure relates to a kit for a system for training detection dogs comprising, consisting essentially of, or consisting of: a central computer; a plurality of olfactometers configured to be operably connected to the central computer, each olfactometer comprising: one or more sampling ports; a plurality of odor channels configured to be placed in fluid communication with the one or more sampling ports; an independent controller configured to be operably coupled to the plurality of odor channels; and a sensor configured to be connected to the one or more sampling ports; one or more covers disposed to cover and uncover one or more of the one or more sampling ports; a cover controller configured to be operably coupled to the one or more covers; a feeder configured to be operably coupled to the cover controller; and one or more tools to assemble the system. In one aspect, the independent controller of each sampling port is operable to be programmed to present an odor from one of the plurality of odor channels to the one or more sampling ports. In another aspect, the one or more sensors of the one or more sampling ports is configured to be disposed to measure a nose hold of a dog at the one or more sampling ports. In another aspect, the cover controller is operable to be programmed to operate the one or more covers. In another aspect, the cover controller is operable to be programmed to operate the feeder when one or more specified conditions are met. In another aspect, the one or more sensors are operable to be configured to determine when one or more specified conditions are met. In another aspect, the central computer is operable to be programmed to operate the system to train detection dogs to indicate detection of a specified odor from the plurality of odor channels. In another aspect, each of the plurality of olfactometers is remotely controllable. In another aspect, each of the plurality of olfactometers is remotely controllable by long-range radio. In another aspect, each of the plurality of olfactometers is portable.

As embodied and broadly described herein, an aspect of the present disclosure relates to a method of training detection dogs comprising, consisting essentially of, or consisting of: providing a dog for training; providing a system for training detection dogs comprising: a central computer; a plurality of olfactometers operably connected to the central computer, each olfactometer comprising: one or more sampling ports; a plurality of odor channels in fluid communication with the sampling port; an independent controller operably coupled to the plurality of odor channels; and one or more sensor connected to the one or more sampling ports; one or more covers disposed to cover and uncover one or more of the one or more sampling ports; a cover controller operably coupled to the one or more covers; and a feeder operably coupled to the cover controller; operating the system to provide one or more odors at the one or more sampling ports from the plurality of odor channels of each of the one or more sampling ports; allowing the dog to sniff each sampling ports; and rewarding or not rewarding the dog according to a performance of the dog in detecting the one or more odors. In another aspect, the independent controller of the one or more sampling ports comprises a program to present an odor from one of the plurality of odor channels to the one or more sampling ports. In another aspect, the one or more sensors of each of the one or more sampling ports is disposed to measure a nose hold of a dog at the one or more sampling ports. In another aspect, the cover controller comprises a program to operate the one or more covers. In another aspect, the cover controller comprises a program to operate the feeder when one or more specified conditions are met. In another aspect, the one or more sensors are operably configured to determine when one or more specified conditions are met. In another aspect, the central computer comprises a program to operate the system to train detection dogs to indicate detection of a specified odor from the plurality of odor channels. In another aspect, each of the plurality of olfactometers is remotely controllable. In another aspect, each of the plurality of olfactometers is remotely controllable by long-range radio. In another aspect, each of the plurality of olfactometers is portable.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents arc considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of.” As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step, or a limitation) or group of integers (e.g., feature(s), element(s), characteristic(s), property(ies), method/process(s) steps, or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about,” “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the devices and/or methods disclosed and claimed herein can be made and executed without undue experimentation in light of the present disclosure. While the devices and/or methods of this invention have been described in terms of particular embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope, and concept of the invention as defined by the appended claims.

Furthermore, no limitations are intended to the details of construction or design herein shown, other than as described in the claims below. It is therefore evident that the particular embodiments disclosed above may be altered or modified and all such variations are considered within the scope and spirit of the disclosure. Accordingly, the protection sought herein is as set forth in the claims below.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order.

To aid the Patent Office, and any readers of any patent issued on this application in interpreting the claims appended hereto, applicants wish to note that they do not intend any of the appended claims to invoke 35 U.S.C. § 112 (f) as it exists on the date of filing hereof unless the words “means for” or “step for” are explicitly used in the particular claim.

### REFERENCES

1. Edwards T L. Automated canine scent-detection apparatus: technical description and training outcomes. Chem Senses. (2019) 44:449-55. doi: 10.1093/chemse/bjz039.
2. Jendrny P, Schulz C, Twele F, Meller S, von Kockritz-Blickwede M, Osterhaus ADME, et al. Scent dog identification of samples from COVID-19 patients-a pilot study. BMC Infect Dis. (2020) 20:536. doi: 10.1186/s12879-020-05281-3.
3. Simon A G, DeGree ff L E, Frank K, Peranich K, Holness H, Furton K G. A method for controlled odor delivery in olfactory field-testing. Chem Senses. (2019) 44:399-408. doi: 10.1093/chemse/bjz031.
4. DeChant M T, Ford C, Hall N J. Effect of handler knowledge of the detection task on canine search behavior and performance. Front Vet Sci. (2020) 7:250. doi: 10.3389/fvets.2020.00250.
5. Walker D B, Walker J C, Cavnar P J, Taylor J L, Pickel D H, Hall S B, et al. Naturalistic quantification of canine olfactory sensitivity. Appl Anim Behav Sci. (2006) 97:241-54. doi:

10.1016/j.applanim.2005.07.009.
6. Fischer-Tenhagen C, Johnen D, Heuwieser W, Becker R, Schallschmidt K, Nehls I.

Odor perception by dogs: evaluating two training approaches for odor learning of sniffer dogs. Chem Senses. (2017) 42:435-41. doi: 10.1093/chemse/bjx020.
7. Hall N J, Smith D W, Wynne C D L. Training domestic dogs (Canis lupus familiaris) on a novel discrete trials odor-detection task. Learn Motiv. (2013) 44:218-28. doi: 10.1016/j.lmot.2013.02.004.
8. Lit L, Schweitzer J B, Oberbauer A M. Handler beliefs affect scent detection dog outcomes. Anim Cogn. (2011) 14:387-94. doi: 10.1007/s10071-010-0373-2.
9. Mancini C, Harris R, Aengenheister B, Guest C. Re-centering multispecies practices: a canine interface for cancer detection dogs. In: Proceedings of the 33rd Annual ACM Conference on Human Factors in Computing Systems. Seoul Republic of Korea: ACM (2015). p. 2673-82. doi: 10.1145/2702123.2702562.
10. Buettner A editor. Springer Handbook of Odor. Cham: Springer International Publishing (2017). doi: 10.1007/978-3-319-26932-0.
11. Brattoli M, De Gennaro G, De Pinto V, Loiotile A D, Lovascio S, Penza M. Odour detection methods: olfactometry and chemical sensors. Sensors. (2011) 11:5290-322. doi: 10.3390/s110505290.
12. Slotnick B, Restrepo D. Olfactometry with mice. Curr Protoc Neurosci. (2005) 33:8-20. doi: 10.1002/0471142301.ns0820 s33.
13. Pacharra M, Kleinbeck S, Schaper M, Hucke C I, van Thriel C. Sniffin' sticks and olfactometer-based odor thresholds for n-butanol: correspondence and validity for indoor air scenarios. Atmosphere. (2020) 11:472. doi: 10.3390/atmos11050472.
14. Hall N J, Collada A, Smith D W, Wynne C D L. Performance of domestic dogs on an olfactory discrimination of a homologous series of alcohols. Appl Anim Behav Sci. (2016) 178:1-6. doi: 10.1016/j.applanim.2016. 03.016.
15. Hall N J, Smith D W, Wynne C D L. Effect of odorant pre-exposure on domestic dogs' sensitivity on an odorant detection task. Appl Anim Behav Sci. (2016) 178:80-7. doi: 10.1016/j.applanim.2016.02.003.
16. Hall N J, Wynne C D L. Odor mixture training enhances dogs' olfactory detection of home-made explosive precursors. Heliyon. (2018) 4: e00947. doi: 10.1016/j.heliyon.2018.e00947.
17. Marshall D A, Blumer L, Moulton D G. Odor detection curves for npentanoic acid in dogs and humans. Chem Senses. (1981) 6:445-53. doi: 10.1093/chemse/6.4.445.
18. Moulton D G, Marshall D A. The performance of dogs indetecting?-ionone in the vapor phase. J Comp Physiol. (1976) 110:287-306. doi: 10.1007/BF00659145.
19. Moulton D G, Ashton E H, Eayrs J T. Studies in olfactory acuity: I V. Relative detectability of n-aliphatic acids by the dog. Anim Behav. (1960) 8:117-28. doi: 10.1016/0003-3472 (60) 90019-1.
20. Waggoner L P, Johnston J M, Williams M, Jackson J, Jones M H, Boussom T, et al. Canine olfactory sensitivity to cocaine hydrochloride and methyl benzoate. In: Pilon P, Burmeister S, editors. Proceedings Volume 2937, Chemistry- and Biology-Based Technologies for Contraband Detection. Boston, M A (1997). p. 216-26. doi: 10.1117/12.266775.
21. Signal developers. Signal: Signal processing (2014). Available online at: http://r-forge.r-project.org/projects/signal/(accessed Aug. 31, 2021).
22. Johnen D, Heuwieser W, Fischer-Tenhagen C. Canine scent detection-Fact or fiction? Appl Anim Behav Sci. (2013) 148:201-8. doi: 10.1016/j.applanim.2013.09.002.
23. Elliker K R, Sommerville B A, Broom D M, Neal D E, Armstrong S, Williams H C. Key considerations for the experimental training and evaluation of cancer odour detection dogs: lessons learnt from a double-blind, controlled trial of prostate cancer detection. BMC Urol. (2014) 14:22. doi: 10.1186/1471-2490-14-22.
24. Fischer-Tenhagen C, Tenhagen B-A, Heuwieser W. Short communication: ability of dogs to detect cows in estrus from sniffing saliva samples. J Dairy Sci. (2013) 96:1081-4. doi: 10.3168/jds.2012-5683.
25. Fischer-Tenhagen C, Wetterholm L, Tenhagen B-A, Heuwieser W. Training dogs on a scent platform for oestrus detection in cows. Appl Anim Behav Sci. (2011) 131:63-70. doi: 10.1016/j.applanim.2011.01.006.
26. Reardon M R, MacCrehan W A. Developing a quantitative extraction technique for determining the organic additives in smokeless handgun powder. JFS. (2001) 46:802-7. doi: 10.1520/JFS15051J.
Abel, R. J., Lunder, J. L., & Harynuk, J. J. (2020). A novel protocol for producing low-abundance targets to characterize the sensitivity limits of ignitable liquid detection canines. Forensic Chemistry, 18, Article 100230. https://doi.org/10.1016/j.forc.2020.100230.
Aviles-Rosa, E. O., Gallegos, S. F., Prada-Tiedemann, P. A., & Hall, N. J. (2021). An automated canine line-up for detection dog research. Frontiers in Veterinary Science, 8, Article 775381. https://doi.org/10.3389/fvets.2021.775381.
Aviles-Rosa, E. O., DeChant, M. T., Prada-Tiedemann, P. A., & Hall, N. J. (in press). A laboratory model of canine search vigilance decrement, I. Journal of Experimental Analysis of Behavior.
Chan, C. K. J., & Harris, J. A. (2019). The partial reinforcement extinction effect: The proportion of trials reinforced during conditioning predicts the number of trials to extinction. Journal of Experimental Psychology: Animal Learning and Cognition, 45 (1), 43-58. https://doi.org/10.1037/xan0000190.
DeChant, M. T., Ford, C., & Hall, N. J. (2020). Effect of handler knowledge of the detection task on canine search behavior and performance. Frontiers in Veterinary Science, 7, Article 250. https://doi.org/10.3389/fvets.2020.00250.
DeChant, M. T., Aviles-Rosa, E., Prada-Tiedemann, P. A., & Hall, N. J. (in press). A laboratory model of canine search vigilance decrement, I I: Noncontingent reward and Pavlovian appetitive stimuli. Journal of Experimental Analysis of Behavior.
Fox, J., & Weisberg, S. (2018). An R companion to applied regression. SAGE.
Gazit, I., Goldblatt, A., & Terkel, J. (2005). The role of context specificity in learning: The effects of training context on explosives detection in dogs. Animal Cognition, 8 (3), 143-150. https://doi.org/10. 1007/s10071-004-0236-9.
Harris, J. A., Kwok, D. W. S., & Gottlieb, D. A. (2019). The partial reinforcement extinction effect depends on learning about non-reinforced trials rather than reinforcement rate. Journal of Experimental Psychology: Animal Learning and Cognition, 45 (4), 485-501. https://doi.org/10.1037/xan0000220.
Haselgrove, M., Aydin, A., & Pearce, J. M. (2004). A partial reinforcement extinction effect despite equal rates of reinforcement during Pavlovian conditioning. Journal of Experimental Psychology: Ani-mal Behavior Processes, 30 (3), 240-250. https://doi.org/10.1037/0097-7403.30.3.240.
Jezierski, T., Adamkiewicz, E., Walczak, M., Sobczyn'ska, M., Go′recka-Bruzda, A., Ensminger, J., & Papet, E. (2014). Efficacy of drug detection by fully-trained police dogs varies by breed, training level, type of drug and search environment. Forensic Science International, 237, 112-118. https://doi.org/10.1016/j.forsciint.2014.01.013.
Kuznetsova, A., Brockhoff, P. B., & Christensen, R. H. B. (2017). ImerTest package: Tests in linear mixed effects models. Journal of Statistical Software, 82 (13), 1-26. https://doi.org/10.18637/jss.v082.i13.
Lenth, R. L. (2016). Least-squares means: The R package Ismeans. Journal of Statistical Software, 1 (69), 1-33.
Lewis, D. J. (1960). Partial reinforcement: A selective review of the literature since 1950. Psychological Bulletin, 57 (1), 1-28. https://doi. org/10.1037/h0040963.
MacLean, E. L., & Hare, B. (2018). Enhanced selection of assistance and explosive detection dogs using cognitive measures. Frontiers in Veterinary Science, 5, Article 236. https://doi.org/10.3389/fvets.2018.00236.
Marks, A. (2002). Drug detection dogs and the growth of olfactory surveillance: Beyond the rule of law? Surveillance & Society, 4 (3), Article 3450. https://doi.org/10.24908/ss.v413.3450.
Nevin, J. A. (1988). Behavioral momentum and the partial reinforcement effect. Psychological Bulletin, 103 (1), 44-56. https://doi.org/10.1037/0033-2909.103.1.44.
Porritt, F., Shapiro, M., Waggoner, P., Mitchell, E., Thomson, T., Nicklin, S., & Kacelnik, A. (2015). Performance decline by search dogs in repetitive tasks, and mitigation strategies. Applied Animal Behaviour Science, 166, 112-122. https://doi.org/10.1016/j. applanim.2015.02.013.
Thrailkill, E. A., Kacelnik, A., Porritt, F., & Bouton, M. E. (2016). Increasing the 10 persistence of a heterogeneous behavior chain: Studies of extinction in a rat model of search behavior of working dogs. Behavioural Processes, 129, 44-53. https://doi.org/10.1016/j.beproc.2016.05.009.

What is claimed is:

1. A system for training detection dogs comprising:
a central computer;
a plurality of olfactometers operably connected to the central computer, each olfactometer comprising:
one or more sampling ports;
a plurality of odor channels in fluid communication with the one or more sampling ports;
an independent controller operably coupled to the plurality of odor channels; and
one or more sensors connected to the one or more sampling ports;
one or more covers disposed to cover and uncover one or more of the one or more sampling ports;
a cover controller operably coupled to the cover; and
a feeder operably coupled to the cover controller.

2. The system of claim 1, wherein the independent controller of the one or more sampling ports comprises a program to present an odor from one of the plurality of odor channels to the one or more sampling ports.

3. The system of claim 1, wherein the one or more sensors of the one or more sampling ports is disposed to measure a nose hold of a dog at the one or more sampling ports.

4. The system of claim 1, wherein the cover controller comprises a program to operate the one or more covers or to operate the feeder when one or more specified conditions are met, or both.

5. The system of claim 1, wherein the one or more sensors are operably configured to determine when one or more specified conditions are met.

6. The system of claim 1, wherein the central computer comprises a program to operate the system to train detection dogs to indicate detection of a specified odor from the plurality of odor channels.

7. The system of claim 1, wherein each of the plurality of olfactometers is remotely controllable, is remotely controllable by long-range radio, or is portable.

8. A kit for training detection dogs comprising:
a central computer;
a plurality of olfactometers configured to be operably connected to the central computer, each olfactometer comprising:
one or more sampling ports;
a plurality of odor channels configured to be in fluid communication with the one or more sampling ports;
an independent controller configured to be operably coupled to the plurality of odor channels; and
one or more sensors configured to be connected to the one or more sampling ports;
one or more covers disposed to cover and uncover one or more of the one or more sampling ports;
a cover controller configured to be operably coupled to the one or more covers;
a feeder configured to be operably coupled to the cover controller; and
one or more tools to assemble the system.

9. The kit of claim 8, wherein the independent controller of each sampling port is operable to be programmed to present an odor from one of the plurality of odor channels to the one or more sampling ports, or both.

10. The kit of claim 8, wherein the one or more sensors of the one or more sampling ports is configured to be disposed to measure a nose hold of a dog at the one or more sampling ports.

11. The kit of claim 8, wherein the cover controller is operable to be programmed to operate the one or more covers or to operate the feeder when one or more specified conditions are met.

12. The kit of claim 8, wherein the one or more sensor are operable to be configured to determine when one or more specified conditions are met.

13. The kit of claim 8, wherein the central computer is operable to be programmed to operate the system to train detection dogs to indicate detection of a specified odor from the plurality of odor channels.

14. The kit of claim 8, wherein each of the plurality of olfactometers is remotely controllable, or is remotely controllable by long-range radio, or is portable.

15. A method of training detection dogs comprising:
providing a system for training detection dogs comprising:
a central computer;
a plurality of olfactometers operably connected to the central computer, each olfactometer comprising:
one or more sampling ports;
a plurality of odor channels in fluid communication with the sampling port;
an independent controller operably coupled to the plurality of odor channels; and
one or more sensor connected to the one or more sampling ports;
one or more covers disposed to cover and uncover one or more of the one or more sampling ports;
a cover controller operably coupled to the one or more covers; and
a feeder operably coupled to the cover controller;
operating the system to provide one or more odors at the one or more sampling ports from the plurality of odor channels of each of the one or more sampling ports;
allowing the dog to sniff each sampling ports; and
rewarding or not rewarding the dog according to a performance of the dog in detecting the one or more odors.

16. The method of claim 15, wherein the independent controller of the one or more sampling ports comprises a program to present an odor from one of the plurality of odor channels to the one or more sampling ports.

17. The method of claim 15, wherein the one or more sensors of each of the one or more sampling ports is disposed to measure a nose hold of a dog at the one or more sampling ports.

18. The method of claim 15, wherein the cover controller comprises a program to operate the one or more covers, or to operate the feeder when one or more specified conditions are met, or both.

19. The method of claim 15, wherein the one or more sensors are operably configured to determine when one or more specified conditions are met.

20. The method of claim 15, wherein the central computer comprises a program to operate the system to train detection dogs to indicate detection of a specified odor from the plurality of odor channels.

21. The method of claim 15, wherein each of the plurality of olfactometers is remotely controllable, is remotely controllable by long-range radio, or is portable.
